(19) United States
(12) Patent Application Publication
(10) Pub. No.: US 2003/0011652 A1
(43) Pub. Date: Jan. 16, 2003

(54) Toner passage control device , and image forming device and image forming method

(76) Inventors: Taichi Itoh, Osaka (JP); Takuya Kitahara, Osaka (JP); Yoshihiro Teshima, Osaka (JP); Akira Fukano, Nara (JP); Masahiro Aizawa, Osaka (JP); Akira Kumon, Osaka (JP); Yoshitaka Kitaoka, Osaka (JP)

Correspondence Address: HARNESS, DICKEY & PIERCE, P.L.C., P.O. BOX 828, BLOOMFIELD HILLS, MI, 48303, US

(21) Appl. No.: 10/168,464

(22) PCT Filed: Feb. 26, 2001
(86) PCT No.: PCT/JP01/01407

(30) Foreign Application Priority Data
Feb. 25, 2000 (JP) 2000-49864
Mar. 31, 2000 (JP) 2000-96377

(51) Int. Cl. B41J 2/06

(52) U.S. Cl. 347/14; 347/55

(57) ABSTRACT

The image forming apparatus includes a toner holding element 10 and a toner passage controller 4 having a plurality of toner passage holes 14, for controlling passage of toner 3. In order to prevent shortage of toner supply from the toner holding element 10 and form a high-quality image at a sufficient image density without producing thin white lines in such an image forming apparatus, the traveling speed of the toner holding element 10 is preset based on the traveling speed of an image receiving means 7 and at least one of the weight per unit area or the length in the scanning direction of the toner 3 that is applied to an image receiving means 7, the weight per unit area of the toner 3 held on the toner holding element 10 or the length of a toner-less region in the main scanning direction, and the number of pixels successively formed at different positions in the main scanning direction through the same toner passage hole 14. Each of control electrodes 15a in a row 14a of the toner passage holes located upstream in the moving direction of the toner holding element is arranged so as not to overlap any control electrode 15b in a row 14b of the toner passage holes or any toner passage hole 14 of the row 14b located downstream in the moving direction of the toner holding element, when viewed from the direction in parallel with the moving direction of the toner holding element. As a result, the amount of toner 3 required to obtain a sufficient recording density can be supplied from the toner holding element 10 to every toner passage hole 14.

### TECHNICAL FIELD

The present invention relates to an image forming apparatus used in a copying machine, facsimile, printer and the like, for forming an image by driving toner from a toner holding element toward a back electrode so as to apply the toner to an image receiving means located therebetween, an image forming method, and a toner passage controller for controlling driving of the toner from the toner holding element toward the back electrode in the image forming apparatus according to an image signal.

### BACKGROUND ART

With recent improvement in capability of personal computers and progress in network technology, high-performance printers and copying machines capable of handling not only a large amount of documents but also color documents are increasingly demanded. However, image forming apparatuses capable of outputting satisfactory monochrome and color documents with high quality at a high processing speed are under development, and appearance of such an image forming apparatus has been awaited.

One example of such technology that is conventionally known in the art is so-called “Toner Jet (registered trademark)” image forming technology for forming an image by driving the toner onto an image receiving means such as recording paper or an intermediate image holding belt by using an electric field.

For example, the image forming apparatuses disclosed in Japanese Publication for Opposition No. 44-26333, U.S. Pat. No. 3,689,935 (Japanese Publication for Opposition No. 60-20747) and Japanese National Phase PCT Laid-Open Publication No. 9-500842 are known as an image forming apparatus of this type. The image forming apparatus disclosed in the specification and drawings of Japanese Patent Application No. 10-100780 will now be described with reference to FIG. 17 as an example of such an image forming apparatus. In FIG. 17, 31 denotes a grounded toner holding element for holding and carrying charged toner, and 32 denotes a regulating blade for controlling the toner amount on the toner holding element 31 to one to three layers while further charging the toner. 33 denotes a supply roller for supplying toner to the toner holding element 31 while charging the toner. 34 denotes a toner passage controller (toner passage control means) having a toner passage hole 35 formed therein and including a control electrode 36 surrounding the toner passage hole 35. A control power supply 37 such as a driving IC applies a voltage corresponding to an image signal to the control electrode 36. 38 is a back electrode, and 39 is a power supply of the back electrode 38. 40 is an image receiving means such as recording paper conveyed on the back electrode 38.

In the above structure, the supply roller 33 and the toner holding element 31 are operated, whereby a uniform toner layer is formed on the toner holding element 31 by the regulating blade 32 and conveyed thereon. In this state, a voltage is applied to the back electrode 38. While moving the image receiving means 40, a voltage corresponding to an image signal is applied from the control power supply 37 to the control electrode 36 in synchronization with the movement of the image receiving means 40. As a result, the toner on the toner holding element 31 is driven onto the image receiving means 40 through the toner passage hole 35 according to the image signal, whereby a required image is formed on the image receiving means 40.

In order to form a fine image of e.g., 600 dpi (600 dots per inch) on the whole surface of the image receiving means 40, the toner passage controller 34 must have toner passage holes 35 at such a pitch. These toner passage holes 35 cannot be arranged in a row. Therefore, as shown in FIG. 18, the toner passage holes 35 and the control electrodes 36 are arranged in a multiplicity of rows (eight rows in the illustrated example). The toner passage holes 35 and the control electrodes 36 have a circular shape. Connection electrodes electrically connected to the respective control electrodes 36 extend on both sides of the toner holding element 31 relative to the moving direction thereof in order to avoid interference therebetween. The connection electrodes are respectively connected to lead wires of the control power supply 37 such as a driving IC for outputting a control voltage.

In the example of FIG. 17, the image receiving means 40 is recording paper or the like, and an image is formed directly thereon. However, the recording paper or the like is likely to have a non-uniform thickness. In addition, the recording paper or the like is likely to change in characteristics due to humidity, and is also likely to be deformed during traveling. Moreover, in the case of a color printer, variation in conveying speed of the recording paper makes it difficult to synchronize the image formation timing of each color, resulting in poor image quality.

Therefore, as disclosed in the specification and drawings of, e.g., Japanese Patent Application No. 10-100780, it is sometimes preferable to use an intermediate image holding belt as the image receiving means 40 so that the image formed thereon is collectively transferred onto recording paper.

This will now be described with reference to FIG. 19. 43 denotes an endless image holding belt serving as the image receiving means 40. The image holding belt 43 is formed from a resin film having a conductive filler dispersed therein and having a resistance of about 10¹⁰ Ω·cm. The image holding belt 43 is mounted on a pair of rollers 44a, 44b. 45 denotes a pickup roller for feeding recording paper 46 one by one from a paper feed tray 46a, and 47 denotes a timing roller for synchronizing the supplied recording paper 46 with an image position. 48 denotes a transfer roller for transferring a toner image formed on the image holding belt 42 to the recording paper 46. The transfer roller 48 is pressed against the roller 44a with the image holding belt 43 interposed therebetween, and receives a transfer voltage. 49 denotes a fixing device for fixing the toner image to the recording paper 46 by heating and pressurizing the recording paper 46 having the toner image transferred thereon.

In order to form a solid black image by the image forming apparatus having the above structure, pixels must be continuously formed on the image receiving means in the horizontal and vertical directions. However, the amount of toner that is supplied from the toner holding element to the toner passage holes is not enough to form the pixels at a sufficient recording density, resulting in short supply of the toner. In such a state, the pixels are formed with an insufficient toner amount, whereby the resultant image has a reduced recording density and also has thin white lines extending in the moving direction of the toner holding element.

If the toner passage holes are arranged in a plurality of rows, e.g., in two rows, a large amount of toner would be consumed at the toner passage holes of the row located upstream in the moving direction of the toner holding element. Therefore, when the toner holding element reaches the toner passage holes of the row located downstream in the moving direction of the toner holding element, it no longer holds a sufficient amount of toner thereon. Accordingly, even if an image is to be formed on the whole surface at the same density, thin lines representing the difference in density will be generated in the arrangement direction of the toner passage holes, i.e., in the direction perpendicular to the moving direction of the toner holding element.

In view of the above problems, in the example described in, e.g., Japanese Laid-Open Publication No. 9-207373, the traveling speed Vs of a toner holding element is higher than the speed Vb at which an image receiving means is conveyed, so that toner-less regions located adjacent to each other in the traveling speed of the toner holding element (hereinafter, referred to as sub scanning direction) do not overlap each other. The toner-less regions are the regions on the toner holding element resulting from driving the toner successively therefrom, i.e., the regions having no toner thereon. Moreover, the amount of toner conveyed by the toner holding element is increased in order to compensate for shortage of the toner in the rotation direction of the toner holding element. For the direction in parallel with the extending direction of the toner holding element (hereinafter, referred to as a main scanning direction), a plurality of toner passage holes in each row are not arranged along a single line. Instead, the plurality of toner passage holes in each row are divided into four groups. The four groups of the toner passage holes are slightly displaced from each other in the sub scanning direction so that toner-less regions on the toner holding element resulting from supplying the toner of the pixels that are adjacent to each other in the sub scanning direction do not overlap each other. In this way, shortage of toner supply is prevented.

In the structure of the above proposed example, in order to prevent shortage of toner supply for the pixels located adjacent to each other in the sub scanning direction, the traveling speed of the toner holding element must be about three times the speed at which the image receiving means is conveyed. If the image receiving means is conveyed at a high speed such as 70 to 100 mm/sec for high-speed recording, the rotation speed of the toner holding element would be 200 mm/sec or more. In order to implement such a speed, the charging amount of toner and thus the applied voltage to the control electrodes must be increased. This causes significant increase in costs.

Another way to prevent shortage of toner supply for the pixels located adjacent to each other in the main scanning direction is to divide the above toner passage holes into four groups. The four groups of the toner passage holes are slightly displaced from each other in the main scanning direction so that toner-less regions on the toner holding element resulting from supplying the toner of the pixels that are adjacent to each other in the main scanning direction do not overlap each other. In this method, when the pixels located adjacent to each other in the sub scanning direction are successively formed in order to form a solid black image or the like, toner-less regions on the toner holding element produced in the previous line, i.e., the toner-less regions resulting from driving the toner through the upstream toner passage holes located adjacent to each other in the main scanning direction, may overlap the regions on the toner holding element for supplying the toner of the pixels formed by the downstream toner passage holes. This causes shortage of toner supply in the downstream toner passage holes.

In view of this, in the example described in Japanese Laid-Open Publication No. 9-314889, the distance between the centers of adjacent toner passage holes, the length of a toner-less region, the traveling speed of the toner holding element and the line period are defined by relational expressions in order to solve the above problem regarding shortage of toner supply caused by the toner passage holes located adjacent to each other in the main scanning direction.

In this example as well, toner-less regions on the toner holding element produced before a plurality of lines, i.e., the toner-less regions resulting from driving the toner through the upstream toner passage holes located adjacent to each other in the main scanning direction, may overlap the regions on the toner holding element for supplying the toner of the pixels formed by the downstream toner passage holes. This causes shortage of toner supply in the downstream toner passage holes. In order to prevent the toner-less regions produced in a previous line, i.e., the toner-less regions resulting from driving the toner through the upstream toner passage holes located adjacent to each other in the main scanning direction, from overlapping the regions for supplying the toner of the pixels formed by the downstream toner passage holes, the traveling speed of the toner holding element must be about six times the speed at which the image receiving means is conveyed. Such a traveling speed is unfeasible.

One way to compensate for shortage of toner supply is to increase the toner supply amount by increasing the thickness of a toner layer held on the toner holding element. In this case, a charging-amount distribution of the toner particles is produced in the thickness direction of the toner layer. This destabilizes driving of the toner through the toner passage holes. Moreover, the toner particles are not driven into the toner passage holes in a thin-film state but in an agglomerate state. This accelerates clogging of the toner passage holes.

In other words, in a recording method for forming an image by selectively driving the toner onto an image receiving means by an electric field, an important requirement for obtaining stable driving of the toner and a sufficient recording density is to supply a sufficient and appropriate amount of toner particles from the toner holding element to the toner passage holes of the toner passage controller.

The present invention is made in view of the above conventional problems, and it is an object of the present invention to provide an image forming apparatus for supplying the amount of toner required to obtain a sufficient recording density from a toner holding element, and thus capable of preventing shortage of toner supply to toner passage holes, ensuring a required recording density when a voltage is applied on prescribed conditions, and also stably forming a high-quality image without producing thin white lines and causing reduction in density of the recorded image.

It is another object of the present invention to provide a toner passage controller, an image forming apparatus and an image forming method for supplying the amount of toner required to obtain a sufficient recording density from a toner holding element even in the structure having a plurality of rows of toner passage holes, and thus capable of preventing shortage of toner supply to toner passage holes, ensuring a required recording density when a voltage is applied on prescribed conditions, and also stably forming a high-quality image without producing thin white lines and causing reduction in density of the recorded image.

### DISCLOSURE OF THE INVENTION

In order to achieve the above objects, an image forming apparatus according to one aspect of the present invention includes: a toner holding element holding charged toner, and moving while forming a toner layer thereon; a back electrode mounted at a position facing a position to which the toner on the toner holding element is conveyed, and receiving a voltage for forming a transferring electrostatic field that attracts the toner on the toner holding element; and a toner passage controller mounted between the toner holding element and the back electrode, and including an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. The image forming apparatus further includes an image receiving means disposed between the toner passage controller and the back electrode, and receiving the toner through the toner passage holes. A traveling speed of the toner holding element is preset based on a traveling speed of the image receiving means and at least one of a weight per unit area or a length in the scanning direction of the toner that is applied to the image receiving means, a weight per unit area of the toner held on the toner holding element or a length of a toner-less region in the main scanning direction, and the number of pixels successively formed at different positions in the main scanning direction through the same toner passage hole.

Similarly, an image forming apparatus according to another aspect of the present invention includes: a toner holding element holding charged toner, and moving while forming a toner layer thereon; a back electrode mounted at a position facing a position to which the toner on the toner holding element is conveyed, and receiving a voltage for forming a transferring electrostatic field that attracts the toner on the toner holding element; and a toner passage controller mounted between the toner holding element and the back electrode, and including an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. The image forming apparatus further includes an image receiving means disposed between the toner passage controller and the back electrode, and receiving the toner through the toner passage holes. A traveling speed of the toner holding element is preset based on a traveling speed of the image receiving means and at least one of a ratio of a weight per unit area of the toner that is applied to the image receiving means to a weight per unit area of the toner held on the toner holding element, a ratio of a length in a main scanning direction of the toner that is applied to the image receiving means to a length in the main scanning direction of a toner-less region of the toner holding element, and the number of pixels successively formed at different positions in the main scanning direction through the same toner passage hole.

In the present invention, the traveling speed of the toner holding element may be proportional to a product of the traveling speed of the image receiving means and at least one of the ratio of the weight per unit area of the toner that is applied to the image receiving means to the weight per unit area of the toner held on the toner holding element, the ratio of the length in the main scanning direction of the toner that is applied to the image receiving means to the length in the main scanning direction of the toner-less region of the toner holding element, and the number of pixels successively formed at different positions in the main scanning direction through the same toner passage hole.

In this case, the traveling speed of the toner holding element may be at least a product of the traveling speed of the image receiving means and the ratio of the weight per unit area of the toner that is applied to the image receiving means to the weight per unit area of the toner held on the toner holding element, the ratio of the length in the main scanning direction of the toner that is applied to the image receiving means to the length in the main scanning direction of the toner-less region of the toner holding element, and the number of pixels successively formed at different positions in the main scanning direction through the same toner passage hole.

According to the above structures, parameters in the image forming apparatus such as the traveling speed of the toner holding element and the image receiving means, the weight of the toner per unit area on the toner holding element and the image receiving means, and the pixel size can be optimally preset. As a result, the amount of toner required to obtain a sufficient recording density can be supplied from the toner holding element, thereby preventing shortage of toner supply to the toner passage holes. This ensures a required recording density when the voltages are applied on prescribed conditions, and also enables stable formation of a high-quality image without generating thin white lines and causing reduction in density of the recorded image.

The image forming apparatus may further include a means for determining the traveling speed V0 of the toner holding element according to the following expression:

V0≧N×(D1/D0)×(L1/L0),

where D1 is the weight per unit area of the toner that is applied to the image receiving means, D0 is the weight per unit area of the toner held on the toner holding element, L1 is the length in the main scanning direction of the toner that is applied to the image receiving means, L0 is the length in the main scanning direction of the toner-less region of the toner holding element, N is the number of pixels successively formed at different positions in the main scanning direction through the same toner passage hole, and V1 is the traveling speed of the image receiving means.

According to the above structure, the lower limit of the traveling speed of the toner holding element that is required to ensure the toner supply amount required for stable driving of the toner and a sufficient recording density can be calculated from the specific recording conditions such as the traveling speed of the image receiving means and the pixel size. By setting the traveling speed of the toner holding element to the lower limit or more, the amount of toner required to obtain a sufficient recording density can be supplied from the toner holding element, thereby preventing shortage of toner supply to the toner passage holes. This ensures a required recording density when the voltages are applied on prescribed conditions, and also enables stable formation of a high-quality image without generating thin white lines and causing reduction in density of the recorded image.

The length of the toner-less region of the toner holding element in the main scanning direction may be approximately equal to a length of the control electrode in the main scanning region.

According to the above structure, the length of the control electrode can be substituted for the length of the toner-less region of the toner holding element in the main scanning direction. As a result, the required traveling speed of the toner holding element can be easily obtained without measuring the length of the toner-less region. Moreover, the required traveling speed of the toner holding element can be changed by changing the length of the control electrode in the main scanning direction. This contributes to optimal design of the apparatus.

An image forming apparatus according to still another aspect of the present invention includes: a toner holding element holding charged toner, and moving while forming a toner layer thereon; a back electrode mounted at a position facing a position to which the toner on the toner holding element is conveyed, and receiving a voltage for forming a transferring electrostatic field that attracts the toner on the toner holding element; and a toner passage controller mounted between the toner holding element and the back electrode, and including an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. The image forming apparatus further includes: an image receiving means disposed between the toner passage controller and the back electrode, and receiving the toner through the toner passage holes. A traveling speed of the toner holding element is one to two times that of the image receiving element.

According to the above structure, an image can be formed in a stable region of the traveling speed of the toner holding element, i.e., a region having a saturated recording density and preventing shortage of toner supply. Moreover, an excessive traveling speed of the toner holding element would apply large centrifugal force to the toner held on the toner holding element, thereby causing scattering of the toner. However, the above structure eliminates the need to increase the charging amount of the toner to prevent such scattering of the toner, and also eliminates the need to increase a voltage required to drive the toner. As a result, increase in costs resulting from increasing the voltage can be prevented.

A toner passage controller according to yet another aspect of the present invention is mounted at a position facing a toner holding element holding charged toner and moving while forming a toner layer thereon. The toner passage controller includes an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. Each control electrode on a row of toner passage holes located upstream in a moving direction of the toner holding element is arranged so as not to overlap any toner passage hole of a row located downstream in the moving direction of the toner holding element, when viewed from a direction in parallel with the moving direction of the toner holding element.

An image forming apparatus according to a further aspect of the present invention includes: a toner holding element holding charged toner, and moving while forming a toner layer thereon; a back electrode mounted at a position facing a position to which the toner on the toner holding element is conveyed, and receiving a voltage for forming a transferring electrostatic field that attracts the toner on the toner holding element; and a toner passage controller mounted between the toner holding element and the back electrode, and including an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. The image forming apparatus further includes an image receiving means disposed between the toner passage controller and the back electrode, and receiving the toner through the toner passage holes. Each control electrode in a row of toner passage holes located upstream in a moving direction of the toner holding element is arranged so as not to overlap any toner passage hole of a row located downstream in the moving direction of the toner holding element, when viewed from a direction in parallel with the moving direction of the toner holding element.

According to the above structures, each toner-less region on the toner holding element resulting from driving the toner through the upstream row of the toner passage holes does not overlap any of the surface regions of the toner holding element that face the downstream toner passage holes. Therefore, regarding the downstream row of the toner passage holes, each toner supply range on the toner holding element entirely covers the corresponding toner passage hole. As a result, the thin-film toner held on the toner holding element is supplied to the entire region across the toner passage hole and around the hole area thereof Accordingly, the length of the pixels formed on the image receiving means from will not be reduced in the main scanning direction, whereby the pixels can be formed with a size required to form an image of a prescribed resolution. Since the length of the pixels formed through the downstream toner passage hole is not reduced in the main scanning direction, thin white lines will not be produced between pixels formed through the downstream toner passage holes and pixels formed through the upstream toner passage holes.

Each toner-less region resulting from driving the toner through the upstream row of the toner passage holes partially overlaps any of the toner supply ranges for driving the toner through the downstream row of the toner passage holes. Therefore, the amount of toner to be supplied to each downstream toner passage hole is reduced. However, increasing the traveling speed of the toner holding element so as to compensate for such reduction in toner supply amount makes it possible to compensate for reduction in recording density resulting from the reduction in toner supply amount.

A toner passage controller according to a still further aspect of the present invention is mounted at a position facing a toner holding element that holds charged toner and moves while forming a toner layer thereon. The toner passage controller includes an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. Each control electrode on a row of toner passage holes located upstream in a moving direction of the toner holding element is arranged so as not to overlap any control electrode in a row of toner passage holes located downstream in the moving direction of the toner holding element, when viewed from a direction in parallel with the moving direction of the toner holding element.

An image forming apparatus including the above toner passage controller may be provided.

According to the above structures, each toner-less region resulting from driving the toner through the upstream row of the toner passage holes does not overlap any of the toner supply ranges for the downstream row of the toner passage holes. Therefore, the amount of toner to be supplied to the downstream toner passage hole will not be smaller than that to be supplied to the upstream toner passage hole. As a result, the recording density will not be reduced in the downstream row of the toner passage holes. Moreover, the traveling speed of the toner holding element required to prevent shortage of toner supply from the toner holding element is the same in both rows of the toner passage holes. Accordingly, the applied voltage and the voltage application time to the control electrodes can be controlled on the same conditions for both rows of the toner passage holes.

A plurality of pixels may be successively formed at different positions in the main scanning direction through the same toner passage hole.

The above structure facilitates implementation of the present invention. More specifically, since a plurality of pixels are formed at different positions in the main scanning direction through the same toner passage hole, adjacent toner passage holes in the main scanning direction can be located away from each other. As a result, the upstream control electrodes and the downstream control electrodes or the toner passage holes can be easily arranged so as not to overlap each other in the main scanning direction. This prevents shortage of toner supply to every row of the toner passage holes, and ensures a required recording density when a voltage is applied on prescribed conditions. Moreover, this enables stable formation of a high-quality image without producing thin white lines and causing reduction in density of the recorded image.

A toner passage controller according to a yet further aspect of the present invention is mounted at a position facing a toner holding element holding charged toner and moving while forming a toner layer thereon. The toner passage controller includes an insulating member and control electrode formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. A length of the control electrode in a main scanning direction, t2, is determined according to the following expression:

NP≦t2≦2NP−Lh,

where N is the number of pixels successively formed at different positions in the main scanning direction through the same toner passage hole, P is a pitch at which pixels are formed on the image receiving means in the main scanning direction, and Lh is a length of the toner passage hole in the main scanning direction.

An image forming apparatus including the above toner passage controller may be provided.

The above structure prevents shortage of toner supply to every row of the toner passage holes, and ensures a required recording density when a voltage is applied on prescribed conditions. Moreover, the above structure enables the control electrodes to be sized to prevent generation of thin white lines.

An image forming apparatus according to a yet further aspect of the present invention includes: a toner holding element holding charged toner, and moving while forming a toner layer thereon; a back electrode mounted at a position facing a position to which the toner on the toner holding element is conveyed, and receiving a voltage for forming a transferring electrostatic field that attracts the toner on the toner holding element; and a toner passage controller mounted between the toner holding element and the back electrode, and including an insulating member and control electrodes formed thereon. The insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal. The image forming apparatus further includes an image receiving means disposed between the toner passage controller and the back electrode, and receiving the toner through the toner passage holes. The number of pixels successively formed at different positions in a main scanning direction through the same toner passage hole, N, is determined according to the following expression:

(t2+Lh)/2P≦N≦t2/P,

where P is a pitch at which the pixels are formed on the image receiving means in the main scanning direction, Lh is a length of the toner passage hole in the main scanning direction, and t2 is a length of the control electrode in the main scanning direction.

A method for forming an image according to a yet further aspect of the present invention includes the steps of: holding charged toner on a toner holding element and moving the toner holding element while forming a toner layer thereon; applying to a back electrode a voltage for forming a transferring electrostatic field that attracts the toner on the toner holding element, the back electrode being mounted at a position facing a position to which the toner on the toner holding element is conveyed; and controlling passage of toner through toner passage holes in a toner passage controller by applying a voltage to control electrodes according to an image signal. The toner passage controller is mounted between the toner holding element and the back electrode and includes an insulating member and control electrodes formed thereon, the insulating member has a row of a plurality of toner passage holes for passing the toner therethrough, and each control electrode surrounds at least a part of the respective toner passage hole. The method further includes the step of applying the toner to an image receiving means through the toner passage holes, the receiving means being disposed between the toner passage controller and the back electrode. The number of pixels successively formed at different positions in a main scanning direction through the same toner passage hole, N, is determined according to the following expression:

(t2+Lh)/2P≦N≦t2/P,

where P is a pitch at which the pixels are formed on the image receiving means in the main scanning direction, Lh is a length of the toner passage hole in the main scanning direction, and t2 is a length of the control electrode in the main scanning direction.

The above structures prevent shortage of toner supply to every row of the toner passage holes, and ensure a required recording density when a voltage is applied on prescribed conditions. The above structures also enable stable formation of a high-quality image without producing thin white lines and causing reduction in density of the recorded image.

### BRIEF DESCRIPTION OF THE DRAWINGS

FIG. 1 is a schematic cross-sectional view of the state where a toner supply unit in an image forming apparatus according to a first embodiment of the present invention is mounted in a housing member;

FIG. 2 is a cross-sectional view of the state where the toner supply unit is being mounted in the housing member;

FIG. 3 is an enlarged view of a portion around toner passage holes of a toner passage controller;

FIG. 4 is a control block diagram of the first embodiment;

FIG. 5 is a timing chart showing the state of a voltage applied to control electrodes and deflecting electrodes of the image forming apparatus;

FIG. 6 illustrates the state where the toner is driven in the image forming apparatus;

FIG. 7 illustrates the state of pixels formed on an image receiving means of the image forming apparatus;

FIG. 8 shows the numerical analysis result of the state of an electric field around the toner passage hole of the image forming apparatus;

FIG. 9 shows the numerical analysis result of the state where the toner is driven around the toner passage hole of the image forming apparatus;

FIG. 10 illustrates operation of supplying the toner from a toner holding element of the image forming apparatus;

FIG. 11 illustrates the quantitative relation of the toner traveling from the toner holding element to the image receiving means in the image forming apparatus;

FIG. 12 shows the experimental result of the relation between the weight of the toner per unit area in the pixels on the image receiving means and the image density in the image forming apparatus of the first embodiment;

FIG. 13 shows the experimental result of the relation between the ratio between the ratio of the traveling speed of the toner holding element to the traveling speed of the image receiving means and the image density in the image forming apparatus according to the first embodiment;

FIG. 14 illustrates operation of supplying the toner from a toner holding element of an image forming apparatus according to a second embodiment;

FIG. 15 illustrates the quantitative relation of the toner traveling from the toner holding element to an image receiving means in the image forming apparatus of the second embodiment;

FIG. 16 is a plan view of the pixels formed on the image receiving means, showing the relation between the pixel size formed on the image receiving means and the size of a control electrode in the image forming apparatus of the second embodiment;

FIG. 17 shows the structure of a main part of a conventional image forming apparatus;

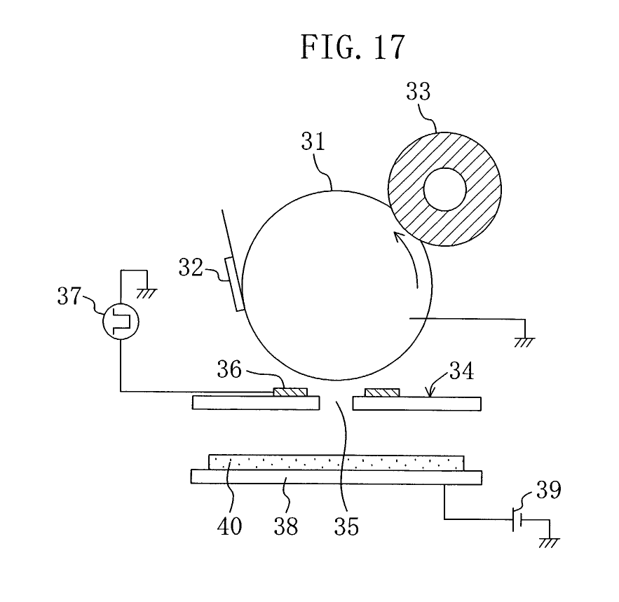

FIG. 18 is an enlarged view of a portion around toner passage holes in the conventional image forming apparatus; and

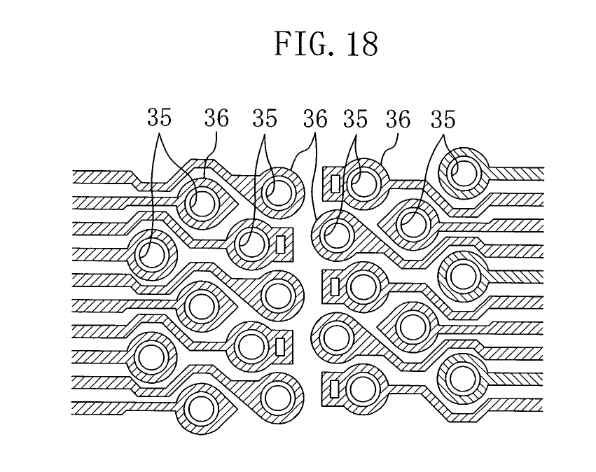

FIG. 19 shows the overall structure of the conventional image forming apparatus.

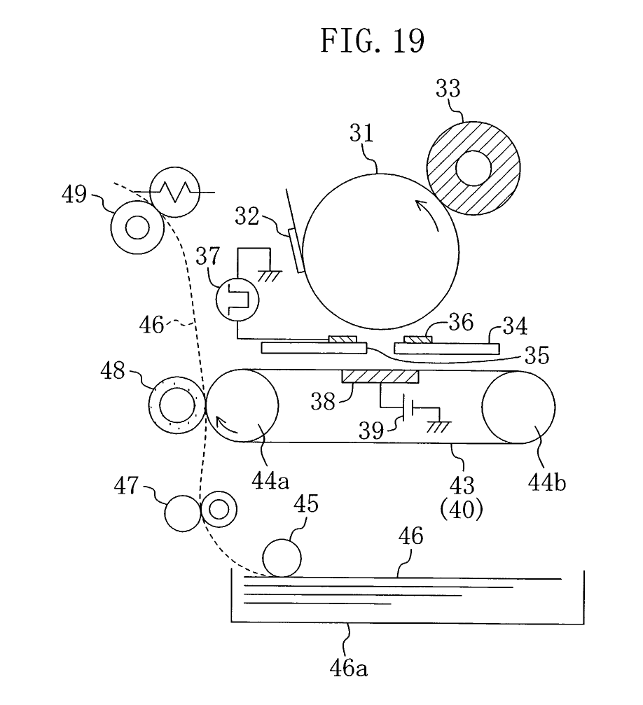

### BEST MODE FOR CARRYING OUT THE INVENTION

The best mode for carrying out the present invention will now be described in terms of embodiments with reference to the accompanying drawings.

(First Embodiment)

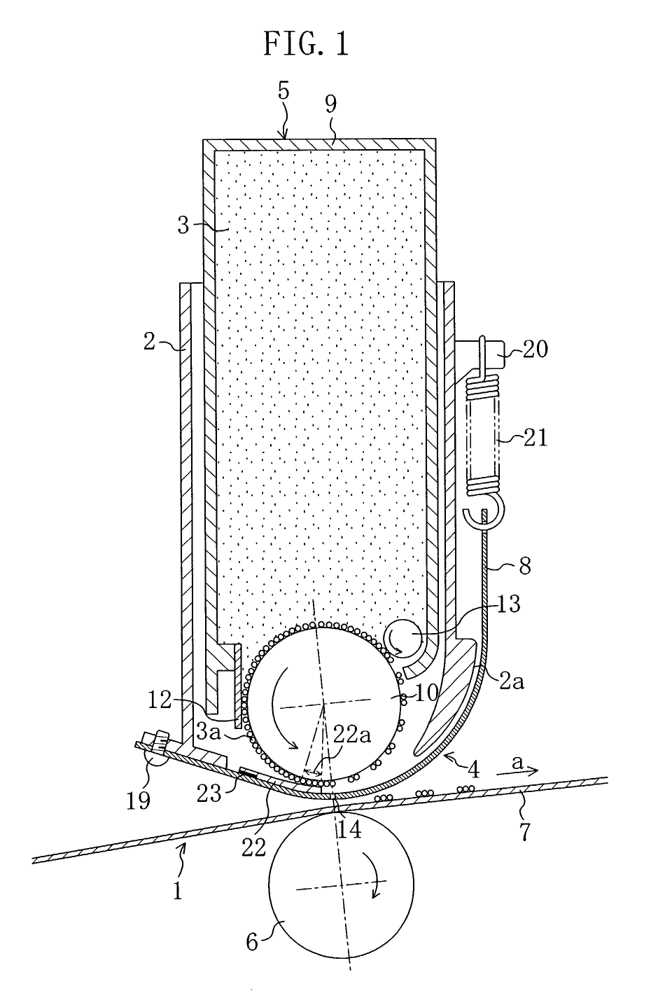

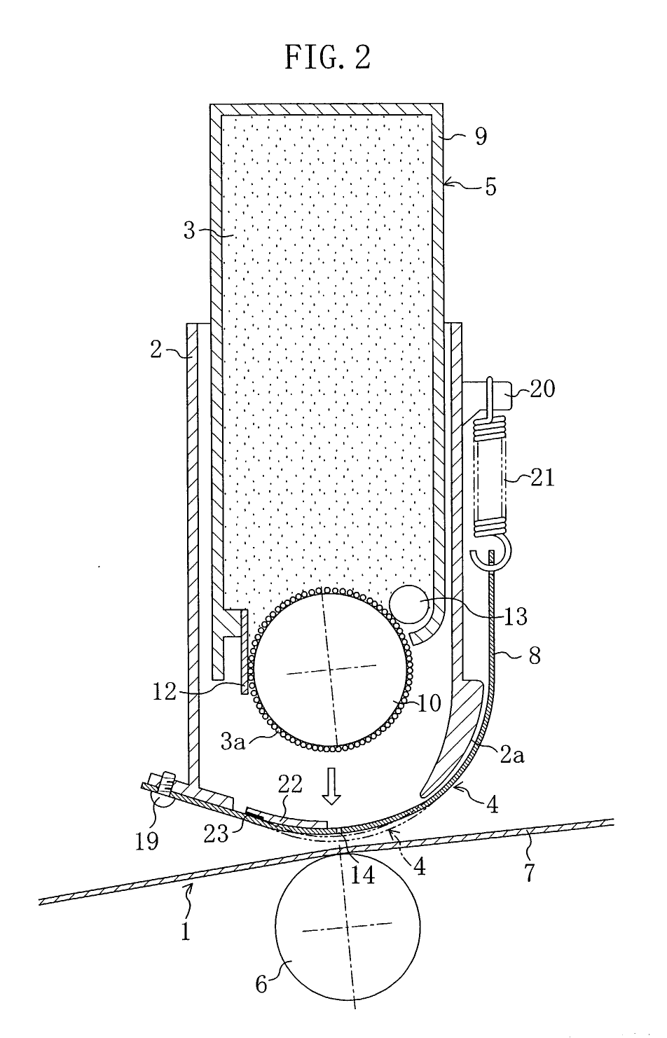

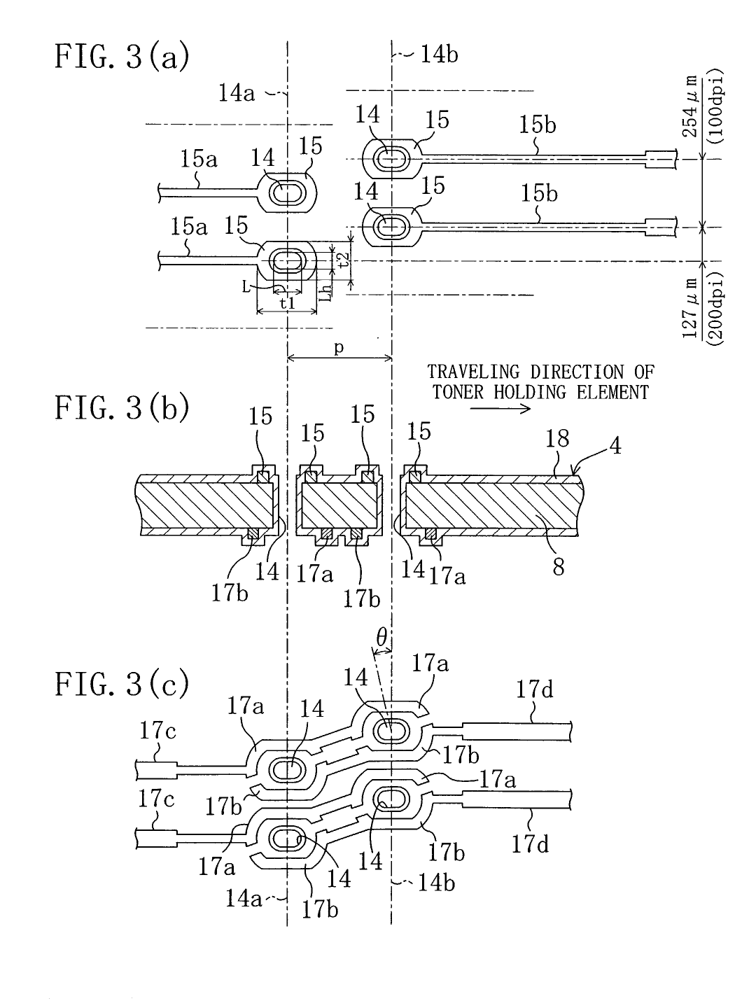

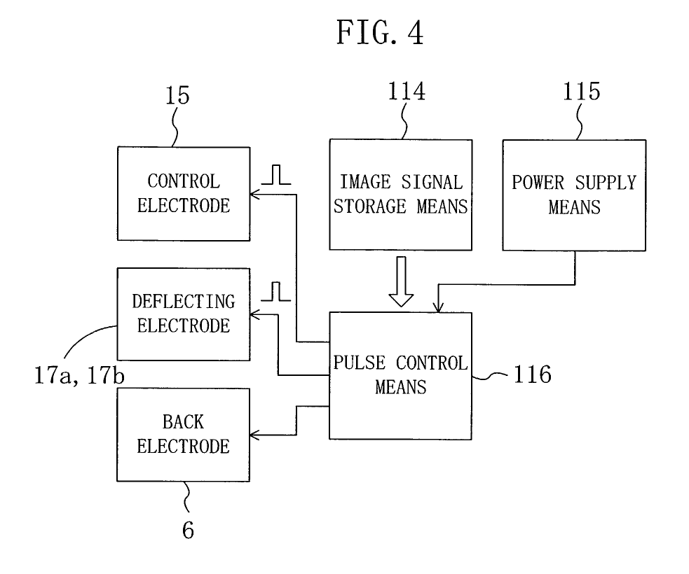

FIGS. 1 and 2 are sectional side elevations of the structure of an image forming apparatus according to the first embodiment of the present invention. FIG. 3 is an enlarged view of an electrode portion of the above image forming apparatus in the planar direction. FIG. 4 is a control block diagram.

In FIG. 1, 1 denotes a print head. The print head 1 includes a housing member 2 opened at its top surface and having an opening formed at its lower end, a toner passage controller 4 (toner passage control means) mounted on the lower outer surface of the housing member 2 so as to cover the opening, and a toner supply unit 5 mounted in the housing member 2. A back electrode 6 is mounted under the print head 1 at an appropriate distance in order to allow an image receiving means 7 such as recording paper to pass between the back electrode 6 and the print head 1.

The toner supply unit 5 includes a storage container 9 for storing toner 3 as a developer, a toner holding element 10 facing an opening formed at the bottom of the storage container 9, a regulating blade 12 for regulating a toner layer 3a held and carried by the toner holding element 10, and a supply roller 13 for frictionally charging the toner 3 within the storage container 9 by stirring, and supplying the toner 3 to the toner holding element 10. As shown in FIG. 2, the toner supply unit 5 is vertically inserted into the housing member 2 in the downward direction in the figure, and mounted at a prescribed position in the housing member 2.

The toner holding element 10 is formed from a metal such as aluminum or iron, or an alloy. In the present embodiment, the toner holding element 10 is a rotary aluminum sleeve having an outer diameter of 20 mm and a thickness of 1 mm, and has a ground potential. The toner holding element 10 holds the toner 3 of, e.g., 0.3 to 0.6 mg/cm², and 0.5 mg/cm² in the present embodiment on its outer peripheral surface, and rotates in the counterclockwise direction of FIG. 1 at 15 to 270 mm/sec, and at 100 mm/sec in the present embodiment.

The regulating blade 12 is formed from an elastic member such as urethane. Appropriately, the hardness thereof is 40 to 80 degrees (JISK6301A scale), the free-end length (the length of the portion protruding from the attachment portion) is 5 to 15 mm, and the linear pressure to the toner holding element 10 is 5 to 40 g/cm. The regulating blade 12 forms one to four toner layers 3a on the toner holding element 10. In the present embodiment, the regulating blade 12 is in an electrically floating state.

The toner 3 is slightly stirred between the toner holding element 10 and the regulating blade 12 and thus electrically charged with the charges received from the toner holding element 10. The toner 3 used in the present embodiment is non-magnetic toner negatively charged at −10 μC/g and having an average particle size of 4 to 8 μm. As described above, the toner holding element 10 holds a thin layer of toner 3 for supply. More specifically, the toner holding element 10 holds the toner 3 in one to four layers in the thickness direction.

The supply roller 13 is formed from a metal shaft of, e.g., iron (with a diameter of 8 mm in the present embodiment) having synthetic rubber such as urethane foam thereon by about 2 to 6 mm so as to have a hardness of 30 degrees (as measured in a roller form by the JISK6301A scale method). The supply roller 13 also electrically charges the toner 3, and controls supply of the toner 3. Preferably, the supply roller 13 is pressed into the toner holding element 10 by about 0.1 to 2 mm.

The toner passage controller 4 is formed from an insulating substrate 8 having a thickness of about 50 μm. The insulating substrate 8 is bent so that its effective width corresponds to that of the toner holding element 10. The insulating substrate 8 has a multiplicity of toner passage holes 14 formed at a small pitch in the width direction of the image receiving means 7 and arranged in one or more rows. Each toner passage hole 14 is surrounded by a ring-shaped control electrode 15 (see FIG. 3). Deflecting electrodes 17a, 17b are formed on the back surface of the insulating substrate 8 (see FIG. 3). The insulating substrate 8 is preferably formed from polyimide, polyethylene terephthalate or the like, and an appropriate thickness thereof is 10 to 100 μm. In the present embodiment, the insulating substrate 8 is formed from polyimide with a thickness of 50 μm.

FIG. 3 shows the portion around the toner passage holes of the toner passage controller 4 in an enlarged manner. More specifically, FIG. 3(a) is an enlarged view of the control electrodes 15, FIG. 3(b) is an enlarged view of the toner passage holes 14, and FIG. 3(c) is an enlarged view of the deflecting electrodes 17a, 17b. As described above, the toner passage controller 4 is formed from the insulating substrate 8 having a multiplicity of toner passage holes 14 formed at a prescribed pitch in parallel with the toner holding element 10 and arranged in a row(s). The toner passage holes 14 are herein arranged in two rows 14a, 14b in the moving direction of the toner holding element 10 (in the horizontal direction in FIG. 3). Moreover, the toner passage holes 14 of the rows 14a, 14b are arranged in a staggered manner. In each row 14a, 14b, the toner passage holes 14 are arranged at a pitch of 254 μm. The row 14a of the toner passage holes 14 is located upstream in the moving direction of the toner holding element 10 at a position about 100 to 400 μm away from the vertical line extending from the center of the toner holding element 10 to the back electrode 6. Similarly, the row 14b of the toner passage holes 14 is located downstream in the moving direction of the toner holding element 10 at a position about 100 to 400 μm away from the vertical line. The distance p between the rows 14a, 14b of the toner passage holes 14 is an integral multiple of the pixel pitch in the sub scanning direction. In the present embodiment, the distance p is X times the pixel pitch in the sub scanning direction (e.g., X=8).

The planar shape of each toner passage hole 14 is a long hole whose length L along the moving direction of the toner holding element 10 (the length in the sub-scanning direction) is greater than the length Lh in the direction perpendicular thereto (the length in the main scanning direction) (Lh<L). In the illustrated example, the length L is about 100 μm and the width Lh is about 60 to 80 μm.

As shown in FIGS. 3(a) and 3(b), the control electrodes 15 are formed on the top surface of the insulating substrate 8 so as to surround the respective toner passage holes 14. The width t1 of the control electrode 15 along the major-axis direction of the toner passage hole 14 is larger than the width t2 (<t1) along the minor-axis direction thereof. More specifically, t1 is preferably 150 to 300 μm, and t2 is preferably 100 to 200 μm. In the present embodiment, t1=180 μm and t2=120 μm. The control electrodes 15 are connected to a driving IC thereof (not shown). The control electrodes 15 of the row 14a located upstream in the moving direction of the toner holding element 10 (i.e., located on the left side in the figure) are connected to the driving IC through electrode leads 15c that extend in the upstream direction. The control electrodes 15 of the row 14b located downstream are connected to the driving IC through electrode leads 15d that extend in the downstream direction.

As shown in FIGS. 3(b) and 3(c), a pair of deflecting electrodes 17a, 17b surrounding the corresponding toner passage holes 14 are formed on the lower surface of the insulating substrate 8. The pair of deflecting electrodes 17a, 17b face each other along the direction tilted at an angle θ defined by tan θ=⅓, i.e., θ=18.4°, from the center line of the row 14a, 14b of the toner passage holes 14. The deflecting electrodes 17a, 17b are connected to a driving IC thereof (not shown). The deflecting electrodes 17a located on one side of the toner passage holes 14 are connected to the driving IC through electrode leads 17c. Each electrode lead 17c connects the respective deflecting electrodes 17a of the rows 14a, 14b to each other and extends upstream in the moving direction of the toner holding element 10. The deflecting electrodes 17b located on the other side of the toner passage holes 14 are connected to the driving IC through electrode leads 17d. Each electrode lead 17d connects the respective deflecting electrodes 17b of the rows 14a, 14b to each other and extends downstream in the moving direction of the toner holding element 10.

These electrodes 15, 17a, 17b are each formed from a Cu film patterned on the insulating substrate 8 and having a thickness of about 8 to 20 μm. In order to prevent short-circuit of the electrodes 15, 17a, 17b, an insulating film 18 of 5 to 30 μm is coated on the surface of the toner passage controller 4. Note that, although the toner passage holes 14 have an elliptical shape in the illustrated example, it may have another shape such as circular or oval shape. Moreover, the material, size, structure and the like of the toner passage controller 4 are not limited to those described above, and the toner passage controller 4 may be designed arbitrarily.

A voltage of 400 V or less is normally applied to the control electrodes 15. In the present embodiment, a voltage of 250 V is applied in order to form dots, and a voltage of −50 V is applied in order not to form dots.

Referring back to FIGS. 1 and 2, the toner passage controller 4 is fixed to the housing member 2 at the end located upstream in the moving direction of the toner holding element 10 (i.e., the end located rearward in the moving direction) by an attachment means 19, rather than being fixed by the contact point with the toner holding element 10. The toner passage controller 4 is then bent along a stay portion 2a (bent portion) of the housing member 2 that has a curvature smaller than that of the outer diameter portion of the toner holding element 10. At the end located downstream in the moving direction of the toner holding element 10 (i.e., the end located forward in the moving direction), the toner passage controller 4 is fixed to an attachment means 20 projecting from the housing member 2 by means of a tension spring 21 (it should be understood that the relation between the upstream and downstream portions of the toner passage controller 4 may be opposite to that described above). Appropriately, the tension spring 21 generates a contact pressure of 1.96 to 19.6×10⁻³ N/mm² between the toner holding element 10 and the toner passage controller 4. The reason for this is as follows: in order to maintain the distance between the toner holding element 10 and the toner passage controller 4 at the position of the toner passage holes 14, the toner holding element 10 and the toner passage controller 4 must always contact each other in the same state according to deviation of the center of rotation axis of the toner holding element 10. Moreover, the toner layer 3a on the toner holding element 10 must be prevented from being deformed by an excessive contact pressure. The contact pressure slightly varies depending on the respective materials of the toner holding element 10 and the toner passage controller 4 and the like.

A spacer 22 is mounted on the surface of the toner passage controller 4 that faces the toner holding element 10. The spacer 22 contacts the toner holding element 10 through the toner layer 3a thereon. The spacer 22 is fixedly bonded to the toner passage controller 4 by an adhesive layer 23. The spacer 22 contacts the toner holding element 10 in a contact range 22a in order to maintain a fixed distance between the toner holding element 10 and the toner passage controller 4 (i.e., head distance) that is equal to the thickness of the spacer 22. The spacer 22 is a metal sheet or a conductive resin sheet, and preferably has a thickness of 5 to 150 μm, and more preferably, 5 to 20 μm. The adhesive layer 23 is a resin-based or rubber-based adhesive or a double-sided adhesive tape, and preferably has a thickness of 2 to 120 μm, and more preferably, 2 to 5 μm.

In the state where the toner supply unit 5 is mounted in the housing member 2 and the toner holding element 10 and the back electrode 6 are positioned at a prescribed distance, the toner layer 3a on the outer peripheral surface of the toner holding element 10 abuts on the spacer 22. Moreover, the toner passage controller 4 extending from a position at the left end of the housing member 2 is bent along the outer diameter of the stay portion 2a (bent portion) and then elastically held by the housing member 2 by using the suspended tension spring 21 at the downstream end of the housing member 2. The tension spring 21 is displaced against the pressing force from the toner holding element 10 to the spacer 11. As a result, the toner passage controller 4 closely contacts the toner holding element 10 through the spacer 22 across the entire width. The spacer 22 accurately maintains the distance (head distance) of 0 to 200 μm, and in the present embodiment, 10 μm, between the toner layer 3a on the toner holding element 10 and the toner passage controller 4. The tensile force that is applied from the tension spring 21 to the toner passage controller 4 is preset in order to obtain an appropriate contact pressure (1.96 to 19.6×10⁻³ N/mm²) between the toner holding element 10 and the toner passage controller 4 as described above. This tensile force is relatively small for the rigidity of the toner passage controller 4.

The back electrode 6 faces the toner holding element 10 with the toner passage controller 4 interposed therebetween. The back electrode 6 serves as a counter electrode and produces an electric field between the back electrode 6 itself and the toner holding element 10. The back electrode 6 is formed from a metal or resin having a conductive filler dispersed therein. A direct-current voltage of about 500 to 2,000 V is applied to the back electrode 6. In the present embodiment, a voltage of 1,000 V is applied thereto. The distance between the back electrode 6 and the toner holding element 10 is set to 150 to 1,000 μm, and in the present embodiment, 350 μm. The image receiving means 7 such as recording paper passes between the back electrode 6 and the print head 1.

The image receiving means 7 is recording paper, an image holding belt or the like. By using a separate driving means (not shown), the image receiving means 7 is conveyed on a given path between the back electrode 6 and the toner passage controller 4 at 15 to 150 mm/sec, and in the present embodiment, 80 mm/sec, in the same direction as the moving direction of the toner holding element 10, i.e., in the direction shown by arrow a.

Hereinafter, a control system of the back electrode 6, the control electrodes 15 and the deflecting electrodes 17a, 17b will be described with reference to FIG. 4. In FIG. 4, 114 denotes an image signal storage means for storing an image signal corresponding to each pixel.

115 denotes a power supply means for supplying a voltage to the back electrode 6, the control electrodes 15 and the deflecting electrodes 17a, 17b. An applied voltage VP to each control electrode 15 is switched among, e.g., −50 V, 200 V and 250 V, and an applied voltage VDD-L, VDD-R to the deflecting electrodes 17a, 17b is switched among, e.g., 150 V, 0 V and −150 V. An applied electrode to the back electrode 6 is, e.g., 1,000 V.

116 denotes a pulse control means. The pulse control means 116 applies a voltage received from the power supply means 115 to the control electrodes 15, the deflecting electrodes 17a, 17b and the back electrode 6 as a pulse voltage. The pulse voltage is obtained by, e.g., arithmetic operation, based on the image signal corresponding to each pixel stored in the image signal storage means 114.

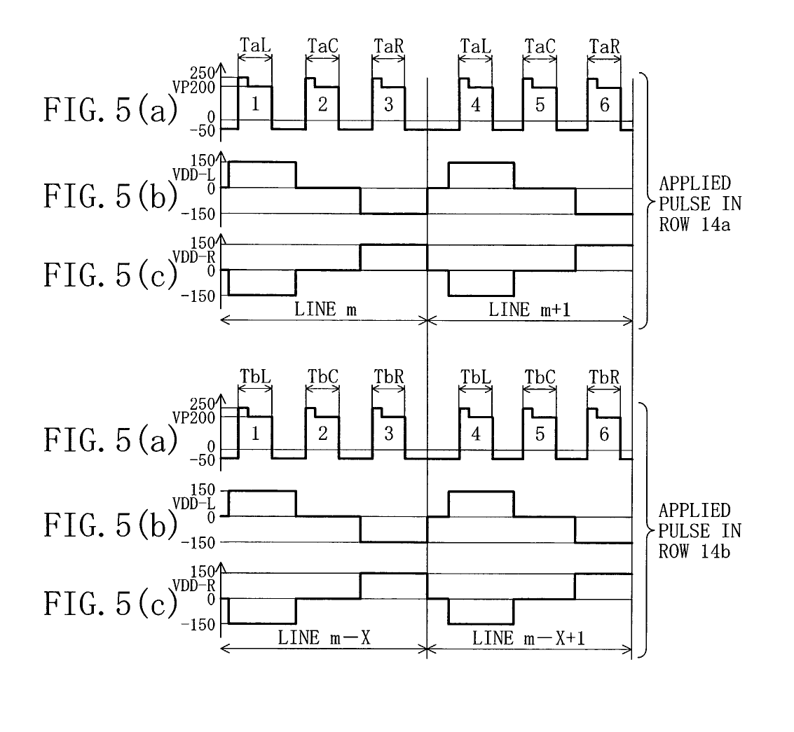

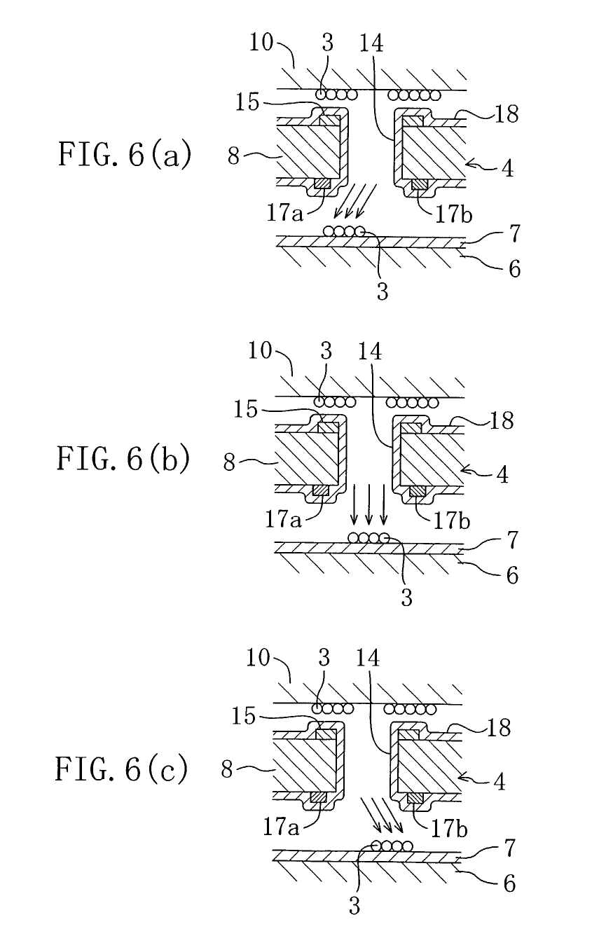

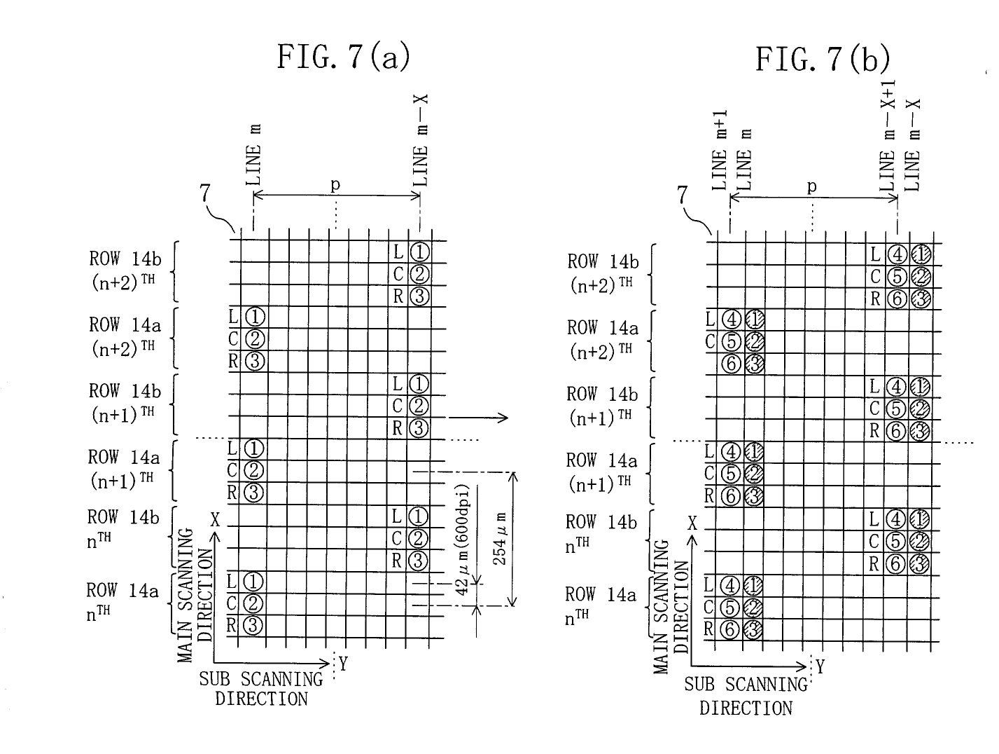

Operation of the image forming apparatus having the above structure will now be described with reference to FIGS. 5 to 7. FIG. 5 is a timing chart showing the state of the voltage applied to the control electrodes 15 and the deflecting electrodes 17a, 17b. FIG. 5(a) shows change in applied voltage VP to each control electrode 15, and FIGS. 5(a) and 5(b) show change in applied voltage VDD-L, VDD-R to the deflecting electrodes 17a, 17b, respectively. FIG. 6 illustrates operation of driving the toner 3, and FIG. 7 illustrates the state of the pixels formed on the image receiving means 7.

First, the process of forming the pixels of line m by the row 14a of the toner passage holes 14 and the process of forming the pixels of line m-X by the row 14b of the toner passage holes 14 will be described. An initial state is first established. The initial state is the state where a voltage of 0 V is applied to the deflecting electrodes 17a, 17b and a voltage of −50 V is applied to the control electrodes 15 regarding both rows 14a, 14b of the toner passage holes 14, so that an electric field produced by the back electrode 6 does not affect the toner 3 adsorbed by the toner holding element 1.

Thereafter, regarding both rows 14a, 14b of the toner passage holes 14, a voltage of +150 V is applied to the left deflecting electrodes 17a and a voltage of −150 V is applied to the right deflecting electrodes 17b in order to deflect the negatively charged toner 3 to the left. In this state, a voltage of 250 V is first applied to the control electrodes 15 in order to separate the toner 3 from the toner holding element 10. A voltage of 200 V is then applied to the control electrodes 15. Regarding the row 14a of the toner passage holes 14, the voltage of 200 V is applied to the control electrodes 15 until time TaL. The time period TaL varies between the individual toner passage holes 14. Regarding the row 14b of the toner passage holes 14, the voltage of 200 V is applied to the control electrodes 15 until time TbL. The time period TbL varies between the individual toner passage holes 14. As a result, as shown in FIG. 6(a), the toner 3 is driven to the left after passing through the toner passage holes 14. The toner 3 is thus applied to the image receiving means 7 at a position that is offset leftward from the position facing the toner passage hole 14 by, e.g., about 40 μm. The weight of the toner per unit area of the pixels formed on the image receiving means 7 is 0.4 to 0.7 mg/cm², and appropriately, 0.5 to 0.6 mg/cm².

Then, a voltage of 0 V is applied to the left and right deflecting electrodes 17a, 17b. In this state, regarding the rows 14a, 14b of the toner passage holes 14, the same voltages as those described above are applied to the control electrodes 15 until time TaC, TbC, respectively. The time period TaC, TbC varies between the individual toner passage holes 14. As a result, as shown in FIG. 6(b), the toner 3 is applied to the image receiving means 7 at the position facing the toner passage hole 14.

Thereafter, a voltage of −150 V is applied to the left deflecting electrodes 17a and a voltage of +150 V is applied to the right deflecting electrodes 17b in order to deflect the negatively charged toner 3 to the right. In this state, regarding the rows 14a, 14b of the toner passage holes 14, the same voltages as those described above are applied to the control electrodes 15 until time TaR, TbR. The time period TaR, TbR varies between the individual toner passage holes 14. As a result, as shown in FIG. 6(c), the toner is applied to the image receiving means 7 at a position that is offset rightward from the position facing the toner passage hole 14 by about 40 μm.

Thus sequentially switching the applied voltages to the control electrodes 15 and the deflecting electrodes 17a, 17b allows the toner to be applied to the three positions, i.e., left, right and central positions, through each toner passage hole 14. As shown in FIG. 7(a), provided that the toner passage holes 14 are arranged at a pitch of 254 μm in each row 14a, 14b, a 600-dpi image can be formed at the positions on lines m and m-X of the image receiving means 7 in numerical order shown in the pixels. Even during the recording operation, the image receiving means 7 is continuously conveyed at a fixed speed in the sub scanning direction Y. As shown in FIG. 3, however, the deflecting electrodes 17a, 17b face each other in the direction tilted at an angle θ defined by tan θ=⅓, i.e., θ=18.4°, from the center line of the row 14a, 14b of the toner passage holes 14. Therefore, the toner 3 deflected to the left and right from the toner passage holes 14 is driven in the direction tilted at 18.4° from the central line of the row 14a, 14b of the toner passage holes 14. This cancels the influence of conveying the image receiving means 7, whereby the tree pixels, i.e., left, right and central pixels, are formed by each toner passage hole 14 in the direction in parallel with the main scanning direction. As described above, the distance p between the rows 14a, 14b of the toner passage holes 14 is X times the pixel pitch in the sub scanning direction. Therefore, driving the toner 3 simultaneously from the rows 14a, 14b of the toner passage holes 14 enables the pixels of lines m and m-X to be formed simultaneously.

By using the rows 14a, 14b of the toner passage holes 14, the pixels of lines m+1 and m−X+1 are then formed by the same method as described above, i.e., by sequentially switching the applied voltages to the control electrodes 15 and the deflecting electrodes 17a, 17b as shown in the right portion of FIG. 5. As a result, the toner 3 is applied to the three positions, i.e., left, right and central positions, through each toner passage hole 14.

As shown in FIG. 7(b), by using the rows 14a, 14b of the toner passage holes 14, an image can be formed at the positions on lines m+1 and m−X+1 of the image receiving means 7 in numerical order shown in the pixels. The image receiving means 7 is herein conveyed by p/X, where p is the distance between the rows 14a and 14b of the toner passage holes 14.

Note that, when no image is to be formed, a voltage of −50 V is applied to the control electrodes 15 so as not to drive the toner 3.

As described above, in the present embodiment, the toner 3 is supplied from the toner layer 3a on the toner holding element 10 to the toner passage holes 14 of the toner passage controller 4. The respective voltages applied to the control electrodes 15 and the deflecting electrodes 17a, 17b are sequentially switched in order to driven the toner in three different directions in the main scanning direction. As a result, pixels are formed on the image receiving means 7. When the traveling speed of the toner holding element 10 and the image receiving means 7, the weight of the toner per unit area of the toner holding element 10 and the image receiving means 7, the pixel size and the like are preset according to the above conditions, the amount of toner 3 required to obtain a sufficient recording density can be supplied from the toner holding element 10, thereby preventing shortage of toner supply to the toner passage holes 14. This ensures a required recording density when the voltages are applied on the prescribed conditions, and also enables stable formation of a high-quality image without generating thin white lines and causing reduction in density of the recorded image.

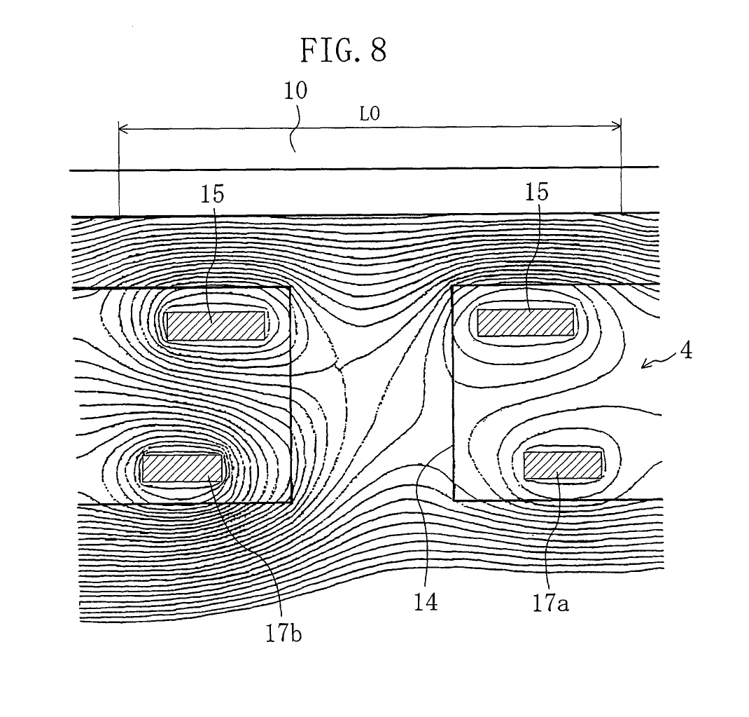

The relation between the toner supply and the resultant pixels in the embodiment of the present invention will now be described with reference to FIGS. 8 to 13. FIG. 8 shows the state of the electric field around the toner passage hole 14 when a voltage for separating the toner 3 from the toner holding element 10 is applied to drive the toner 3 to the right (corresponding to FIG. 6(c)). This state of the electric field was obtained by numerical analysis. In the figure, a voltage of 250 V is applied to the control voltage 15, a voltage of −150 V is applied to the left deflecting electrode 17a, a voltage of +150 V is applied to the right deflecting electrode 17b, and a voltage of 1,000 V is applied to the back electrode 6 (not shown in FIG. 8). The toner holding element 10 is grounded. In the space between the toner holding element 10 and the toner passage controller 4, the equipotential surface in the figure extends concentrically about the right and left ends of the control electrode 15 surrounding the toner passage hole 14. The surface of the toner holding element 10 exhibits the same potential in the range L0 that faces the control electrode 15. Therefore, the toner in this range is subjected to the same force of electric field, and will be separated from the toner holding element 10.

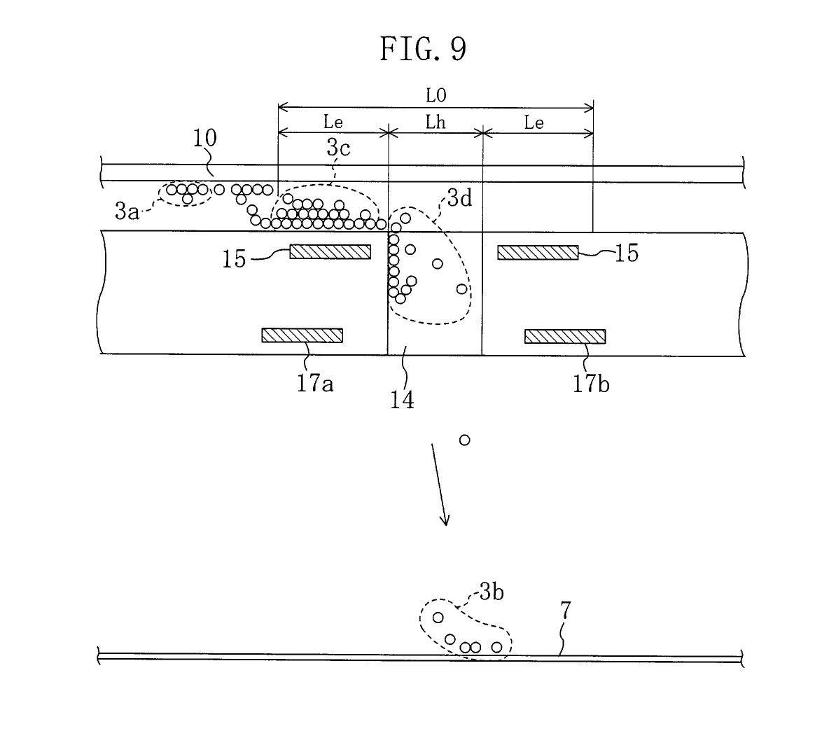

FIG. 9 shows the state where the toner is driven on the same conditions as those described above. This state was obtained by the numerical analysis. Of the toner layer 3a held on the toner holding element 10, the toner 3 that is present in the range L0 facing the control electrode 15 moves toward the toner passage controller 4. Of the toner 3 present in the range L0, toner 3b that is present in the range Lh facing the toner passage hole 14 is applied to the image receiving means 7 through the toner passage hole 14. Toner 3c that is present in the range Le facing the control electrode 15 is deposited on the toner passage controller 4. By turning OFF the voltage applied to the control electrode 15, the toner 3c deposited on the toner passage controller 4 moves toward the toner holding element 10. However, when voltage application to the control electrode 15 is started for the subsequent toner-driving operation, the toner 3c deposited on the toner passage controller 4 in the previous toner-driving operation moves back toward the toner passage controller 4 together with additional toner to be deposited on the toner passage controller 4. In this case, part of the toner on the toner passage controller 4, i.e., toner 3d, is forced out of the range L0 facing the control electrode 15 toward the toner passage hole 14. The toner 3d is then forced into the toner passage hole 14 by the electric field within the toner passage hole 14.

Note that, when part of the toner on the toner passage controller 4, i.e., the toner 3d, is forced out of the range L0 facing the control electrode 15 as described above, it may possibly be forced in two directions, i.e., toward the toner passage hole 14 (inward direction) and toward the outer diameter of the control electrode 15 (outward direction). In the outward direction, there is nowhere for the toner to escape. Therefore, only a limited amount of toner can move in the outward direction. However, the toner forced toward the toner passage hole 14 (i.e., in the inward direction) is sequentially driven toward the image receiving means 7 through the toner passage hole 14 by the electric field. This allows additional toner to be supplied toward the toner passage hole 14. Accordingly, the toner deposited on the region of the toner passage controller 4 corresponding to the control electrode 15 mostly moves toward the toner passage hole 14 (i.e., in the inward direction).

The toner separated from the range L0 of the toner holding element 10 facing the control electrode 15 is sequentially driven toward the image receiving means 7 through the toner passage hole 14 while partially deposited on the toner passage controller 4. As a result, a required amount of toner is supplied to the image receiving means 7. Moreover, in the range Le facing the control electrode 15, the space between the toner passage controller 4 and the toner holding element 10 will not be clogged with the toner deposited on the toner passage controller 4.

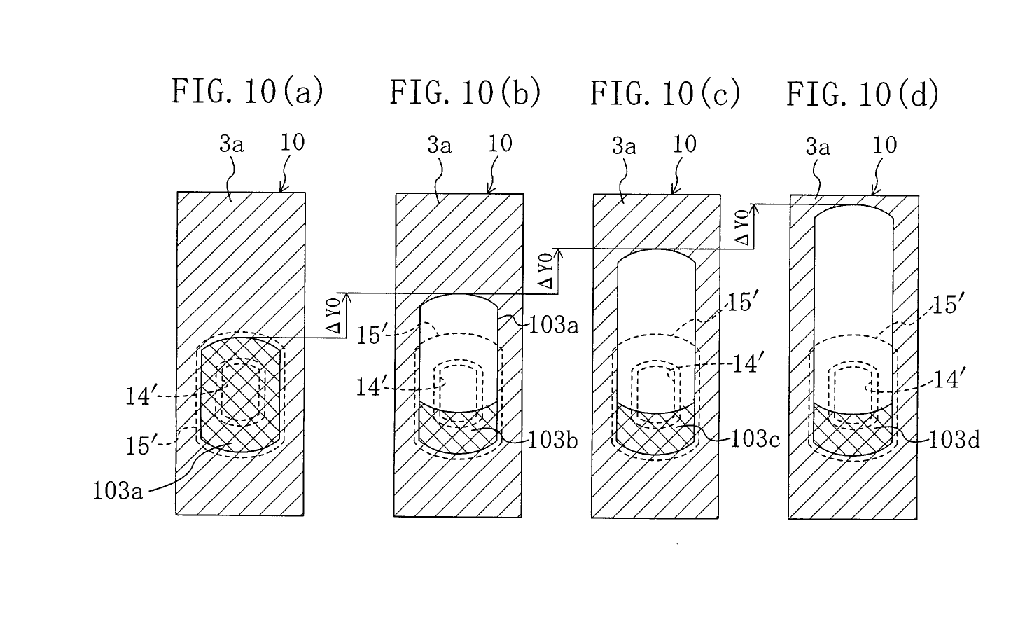

FIG. 10 illustrates the state where a toner-less region is formed in the toner layer 3a on the toner holding element 10 as a result of supplying the toner to form an image. In the figure, the state of the toner layer 3a on the toner holding element 10 is viewed from the toner passage controller 4 before and after formation of three successive pixels.

In FIG. 10, 14′ indicates the position of the toner passage hole 14 projected on the toner layer 3a (the hatched region in the figure) on the toner holding element 10. 15′ indicates the position of the control electrode 15 projected on the toner layer 3a. First, a driving voltage (e.g., 250 V) is applied to the control electrode 15 for the first toner-driving operation. In this case, as shown in FIG. 10(a), the toner is supplied from a toner supply range 103a facing the control electrode 15, as described above. This toner supply range is shown by grid lines in the figure. As a result, the toner 3 in this range is separated from the toner holding element 10 onto the image receiving means 7 and the toner passage controller 4.

As shown in FIG. 10(b), when the toner holding element 10 moves in its moving direction (upward in FIG. 10) by Δ YO, the toner supply range 103a in FIG. 10(a) also moves in the same direction. The toner supply range 103a is a toner-less region having no toner thereon (a white region in FIG. 10(b)) because the toner 3 in that region has already been supplied. A driving voltage is then applied to the control electrode 15 for the second toner-driving operation. In this case, like FIG. 10(a), the toner is supposed to be supplied from the range facing the control electrode 15. However, since no toner 3 is held on the toner-less region (the white region in the figure), the toner is actually supplied from a range 103b facing the control electrode 15, i.e., the range except the toner-less region. Therefore, the toner 3 in the range 103b is separated from the toner holding element 10 onto the image receiving means 7 and the toner passage controller 4. In the third and fourth toner-driving operations, the toner is similarly supplied from ranges 103c, 103d facing the control electrode 15, as shown in FIG. 10(c) and 10(d), respectively.

The area of the toner supply range 103a in the first toner-driving operation (FIG. 10(a)) is greater than that in the second and the following toner-driving operations (FIGS. 10(b) to (d)). As described above, the toner 3 separated from the toner holding element 10 is partially deposited on the toner passage controller 4. Therefore, the separated toner 3 does not entirely move to the image receiving means 7 at a time. However, provided that the applied voltages are the same, the pixel size formed on the image receiving means 7 in the first toner-driving operation tends to be relatively larger than that in the second and the following toner-driving operations.

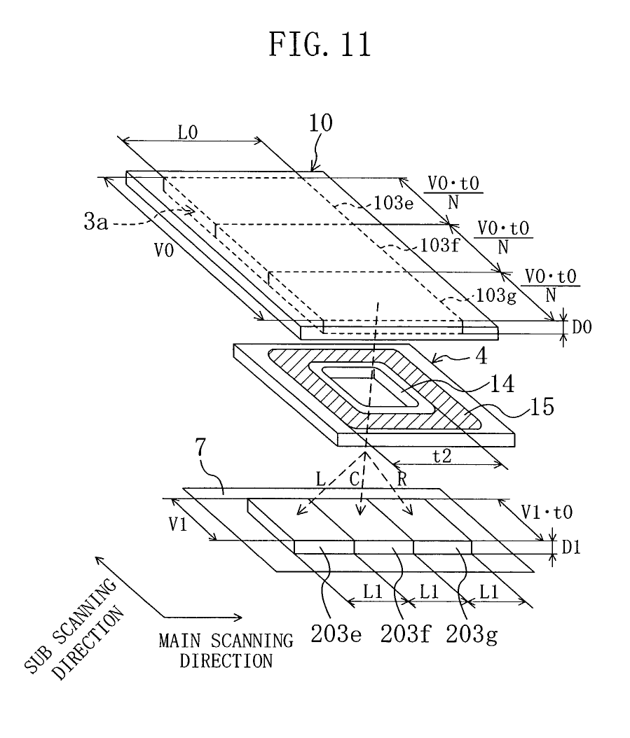

FIG. 11 illustrates the quantitative relation between the amount of toner supplied from the toner holding element 10 and the pixel size formed on the image receiving means 7. As described above in connection with FIG. 10, the amount of toner supplied to the toner holding element 4 varies between the first toner-driving operation and the second and the following toner-driving operations. The toner supply may actually become problematic on the conditions of solid black recording or the like. The second and the following tone-driving operations predominantly affect the recording density in the solid black recording. Therefore, the quantitative relation between the toner supply amount and the pixel size will now be described for the second and the following toner-driving operations. Note that, in FIGS. 10(b) to (d), the toner supply range is shown to have a concave profile corresponding to the profile of the control electrode 15. In the following description, however, it is assumed that the toner supply range is a rectangular region having the same width and height.

As shown in FIG. 11, the toner 3 is deflected to the left (L), central (C) and right (R) directions after passing through the toner passage hole 14. As a result, pixels 203e, 203g, 203f are successively formed on the image receiving means 7 in the main scanning direction. Provided that V1 is the traveling speed of the image receiving means 7 and t0 is a period required to record a single line (i.e., line period), the image receiving means 7 moves by the distance of (V1×t0) during the line period t0. L1 is the length of the pixel in the main scanning direction and corresponds to the pixel pitch in the main scanning direction. In the present embodiment, the pixel pitch is 42 μm (600 dpi). Therefore, L1 is about 42 μm. D1 is the weight of the toner per unit area of the pixels. In the present embodiment, L1=42 μm, D1=0.5 mg/cm², and V1=80 mm/sec, as described above.

In the present embodiment, the control electrode 15 surrounding the toner passage hole 14 in the toner passage controller 4 has a length t2 of 120 μm in the main scanning direction.

The toner for the pixels 203e, 203f, 203g is supplied from toner supply ranges 103e, 103f, 103g of the toner layer 3a on the toner holding element 10, respectively. Provided that V0 is the traveling speed of the toner holding element 10, the toner holding element 10 moves by the distance of (V0×t0) during recording of each line. L0 is the length of the toner supply range in the main scanning direction. As described above, L0 is equal to the length t2 (=L0) of the control electrode 15. D0 is the weight of the toner per unit area of the toner layer. Provided that N is the number of pixels successively formed at different positions along the main scanning direction through the same toner passage hole 14 (herein, N=3), each toner supply range has a length of (V0×t0)IN in the sub-scanning direction. In the present embodiment, L0=120 μm, D0=0.5 mg/cm², and V0=100 mm/sec, as described above.

As described above in connection with FIGS. 9 and 10, a required amount of toner 3 is supplied and transferred from the toner holding element 10 to the image receiving means 7. Therefore, the toner supply ranges 103e to 103g have the same relation with the respective pixels 203e to 203g in terms of the toner amount. In other words, the amount of toner in each toner supply range 103e to 103g, (L0×D0×(⅓)×V0×t0), is equal to the amount to toner in the corresponding pixel 203e to 203g, (L1×D1×V1×t0). Therefore, the following expression is obtained:

L0×D0×V0×t0/N=L1×D1×V1×t0 (1).

In order to prevent shortage of toner supply from the toner holding element 10, the amount of toner to be supplied must be equal to or greater than the amount of toner to be consumed. In other words, the following expression must be satisfied:

L0×D0×V0×t0/N≧L1×D1×V1×t0 (2).

Based on the above expression (2), the traveling speed V0 of the toner holding element 10 for preventing shortage of toner supply is defined by the following expression (3):

V0≧N×(L1/L0)×(D1/D0)×V1 (3).

By substituting the values of the present embodiment, i.e., L1=42 μm, D1=0.5 mg/cm², V1=80 mm/sec, L0=120 μm, D0=0.5 mg/cm² and N=3, for the right side of the above expression (3), the following expression is obtained:

V0≧1.05×V1≈92 mm/sec (4).

Therefore, the traveling speed of the toner holding element 10 in the present embodiment, 100 mm/sec, falls within the range that does not cause shortage of toner supply.

(Experimental Example)

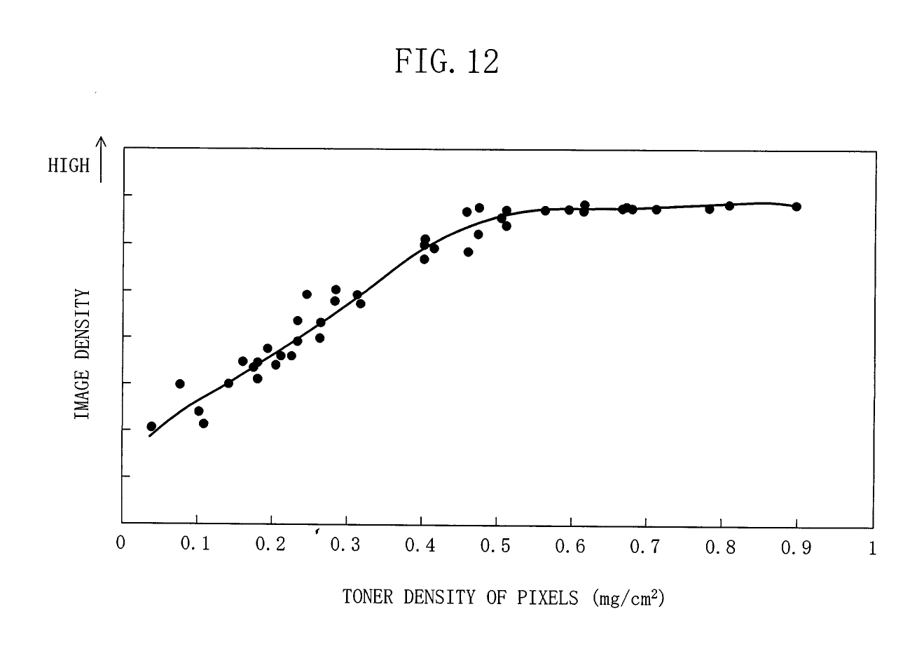

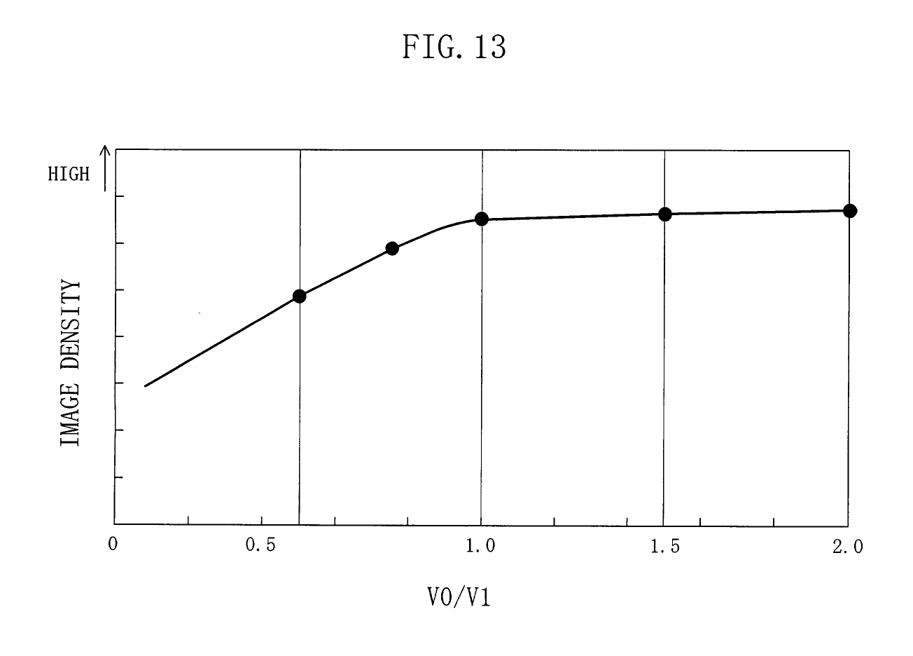

The effects of the present invention were examined by experimentation. The result will now be described. FIG. 12 shows the experimental result of the relation between the weight D1 of the toner per unit area of the pixels formed on the image receiving means 7 and the recording density. In the experimentation, an image was formed by the image forming apparatus of the present embodiment at various traveling speeds V0 of the toner holding element 10, and the recording density of each image was measured. FIG. 13 shows the experimental result of the relation between the ratio of the traveling speed V0 of the toner holding element 10 to the traveling speed V1 of the image receiving means 7, i.e., the ratio V0/V1, and the image density. In the experimentation, an image was formed by the image forming apparatus of the present embodiment at various traveling speeds V0 of the toner holding element 10, and the recording density of each image was measured. As can be seen from FIG. 12, the recording density is saturated when the weight of the toner per unit area is 0.5 mg/cm². Therefore, an optimal weight of the toner per unit area would be 0.5 to 0.6 mg/cm². As can be seen from FIG. 13, the image has a reduced density at the speed ratio V0/V1 of less than about 1.0 due to shortage of toner supply. The recording density is saturated at the speed ratio of 1.0 or more. Accordingly, it is found that shortage of toner supply can be prevented at the speed ratio of 1.0 or more. Moreover, this result is the same as the above expression (4). In the present embodiment, a slight margin was given to the speed ratio V0/V1 of 1.0. The traveling speed V0 of the toner holding element 10 was thus set to 100 mm/sec (the speed ratio V0/V1=1.09).

It was also confirmed that, at the speed ratio V0/V1 of 2 or more, the toner on the toner holding element 10 is subjected to increased centrifugal force and is scattered due to insufficient holding force of the toner holding element 10. In order to prevent such a problem, it is necessary to increase the charging amount of the toner so as to increase the holding force. In this case, however, it is also necessary to increase the applied voltage to the control electrode 15 that is required to separate the toner from the toner holding element 10. This results in increased costs of the driving circuitry and the like. Accordingly, the traveling speed of the toner holding element 10 is preferably set so that the speed ratio V0/V1 falls within the range of 1.0 to 2.0.

As described above, the image forming apparatus of the embodiment of the present invention supplies the toner 3 from the toner layer 3a on the toner holding element 10 to the toner passage hole 14 of the toner passage controller 4. The image forming apparatus then drives the toner in three different directions in the main scanning direction by sequentially switching the voltages applied to the control electrode 15 and the deflecting electrodes 17a, 17b. As a result, pixels are formed on the image receiving means 7. When the traveling speed of the toner holding element 10 and the image receiving means 7, the weight of the toner per unit area on the toner holding element 10 and the image receiving means 7 and the like are preset according to the above conditions, the amount of toner 3 required to obtain a sufficient recording density can be supplied from the toner holding element 10, thereby preventing shortage of toner supply to the toner passage holes 14. This ensures a required recording density when the voltages are applied on the prescribed conditions, and also enables stable formation of a high-quality image without generating thin white lines and causing reduction in density of the recorded image.

(Second Embodiment)

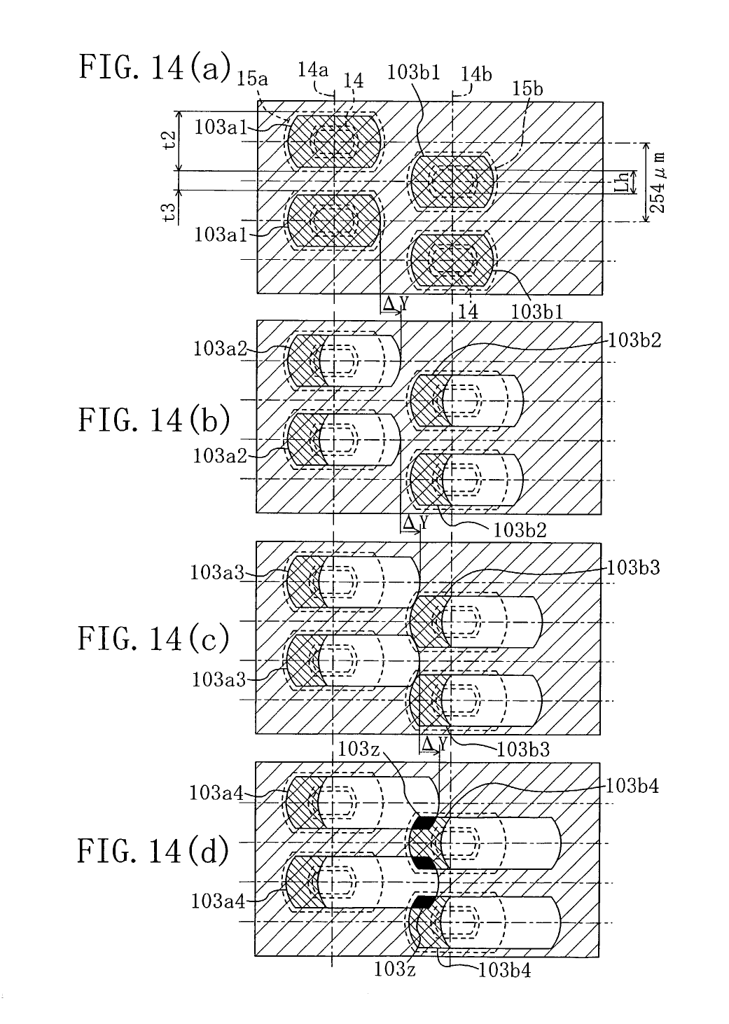

FIGS. 14 to 16 show the second embodiment of the present invention. The second embodiment is basically the same as the first embodiment in terms of the components of the image forming apparatus such as the toner passage controller 4 and the toner supply unit 5 of the print head 1, the back electrode 6, and the toner holding element 10 of the toner supply unit 5 (see FIGS. 1 to 13). The same portions as those in FIGS. 1 to 13 are denoted with the same reference numerals and characters, and description thereof will be omitted.

The present embodiment is different from the first embodiment in that each control electrode 15 in the toner passage controller 4 has a width to of 250 μm in the major-axis direction of the toner passage hole 14, and a width t2 of 170 μm in the minor-axis direction thereof. The toner passage hole 14 has a length Lh of 70 μm in the main scanning direction.

FIG. 14 illustrates the state where a toner-less region is formed in the toner layer 3a on the toner holding element 10 as a result of supplying the toner to form an image in the second embodiment. In the figure, the state of the toner layer 3a on the toner holding element 10 is viewed from the toner passage controller 4 before and after formation of three successive pixels.

In FIG. 14(a), 14a, 14b and 15a, 15b indicate the respective positions of the toner passage holes and the control electrodes projected on the toner layer 3a. In this state, a driving voltage (e.g., 250 V) is applied to the control electrodes 15 for the first toner-driving operation. In this case, as shown in FIG. 14(a), the toner is supplied from toner supply ranges 103a1, 103b1 facing the respective control electrodes 15, as described above. These toner supply ranges are shown by grid lines in the figure. As a result, the toner 3 in these ranges is separated from the toner holding element 10 onto the image receiving means 7 and the toner passage controller 4.

As shown in FIG. 14(b), when the toner holding element 10 moves in its moving direction (rightward in FIG. 14) by Δ Y, the toner supply ranges 103a1, 103b1 in FIG. 14(a) also move in the same direction. The toner supply ranges 103a1, 103b1 are toner-less regions having no toner thereon (white regions in FIG. 14(b)) because the toner 3 in these regions has already been supplied. A driving voltage is then applied to the control electrodes 15 for the second toner-driving operation. In this case, like FIG. 14(a), the toner is supposed to be supplied from the ranges facing the respective control electrodes 15. However, since no toner 3 is held on the toner-less regions (the white regions in the figure), the toner is actually supplied from ranges 103a2, 103b2 facing the respective control electrodes 15, i.e., the ranges except the toner-less regions. Therefore, the toner 3 in these ranges is separated from the toner holding element 10 onto the image receiving means 7 and the toner passage controller 4. In the third toner-driving operation, the toner is similarly supplied from ranges 103a3, 103b3, as shown in FIG. 14(c). In the fourth toner-driving operation, the toner is supposed to be supplied from ranges 103a4, 103b4, as shown in FIG. 14(d). However, each of the actual toner supply ranges 103b4 in the downstream row 14b does not include a region 103z (black region in the figure) that overlaps the toner-less region (white region in the figure) produced by the row 14a of the toner passage holes 14 in the first toner-driving operation. Therefore, the amount of toner 3 to be supplied to the toner passage holes 14 is reduced.

The area of the toner supply range 103a1 in the first toner-driving operation (FIG. 14(a)) is greater than that in the second and the following toner-driving operations (FIGS. 14(b) to (d)). As described above, the toner 3 separated from the toner holding element 10 is partially deposited on the toner passage controller 4. Therefore, the separated toner 3 does not entirely move to the image receiving means 7 at a time. However, provided that the applied voltages are the same, the pixel size formed on the image receiving means 7 in the first toner-driving operation tends to be relatively larger than that in the second and the following toner-driving operations. As described above, the amount of toner 3 to be supplied to the row 14b of the toner passage holes 14 is reduced in the fourth and the following toner-driving operations. Therefore, the traveling speed of the toner holding element 10 is preset so that the amount of toner 3 required to obtain a sufficient image density is supplied to the toner passage holes 14b even on the conditions of the fourth and the following toner-driving operations supplying the smallest amount of toner. Moreover, the applied voltage and the voltage application time to the control electrodes 15 are reduced on the conditions of the toner-driving operations other than the fourth and the following operations, that is, on the conditions of the tone-driving operations supplying a larger amount of toner. As a result, the same image density can be obtained regardless of the conditions.

As described above, the toner passage holes 14 are arranged at a pitch of 254 μm in each row 14a, 14b, and each control electrode 15 has a length t2 of 170 μm in the main scanning direction. Accordingly, the distance t3 between adjacent electrodes is 84 μm in the main scanning direction. As described above, each toner passage hole 14 has a length Lh of 70 μm in the main scanning direction. The distance t3 between adjacent electrodes in the main scanning direction is thus greater than the length Lh of the toner passage hole 14 in the main scanning direction (t3>Lh). This structure eliminates the following problems.

It is herein assumed that each control electrode 15 has a greater length t2 in the main scanning direction, and the distance t3 between adjacent control electrodes in the main scanning direction is smaller than the length Lh of the toner passage hole 14 in the main scanning direction. In this case, each of the toner-less regions (white regions in the figure) produced by the upstream row 14a of the toner passage holes 14 will overlap the corresponding downstream toner passage hole 14 in the main scanning direction. As a result, the length of each toner supply range 103b4 in the main scanning direction becomes shorter than that of the toner passage hole 14 in the main scanning direction. Therefore, the thin-film toner 3 on the toner holding element 10 will not be supplied to a region around the hole area of each downstream toner passage hole 14. As a result, the amount of pixels formed on the image receiving means 7 is reduced in the main scanning direction. The pixels cannot be formed with a size required to form an image of a prescribed resolution (600 dpi in the present embodiment). Moreover, the pixels formed by the downstream toner passage holes 14 have a reduced length in the main scanning direction. As a result, thin white lines are produced between the pixels formed by the downstream toner passage holes and the pixels formed by the upstream toner passage holes.

In contract, in the structure of the present embodiment, the toner is supplied from the toner supply ranges 103b4 to the downstream row 14b of the toner passage holes 14 in the fourth toner-driving operation, as shown in FIG. 14(d). Each of the toner supply ranges 103b4 does not include a region 103z overlapping the toner-less region (white region in the figure) produced by the upstream row 14a of the toner passage holes 14. Therefore, the amount of toner 3 to be supplied to the downstream toner passage holes 14 is reduced. However, each toner supply range 103b4 covers the entire hole area of the toner passage hole 14. Therefore, the thin-film toner 3 on the toner holding element 10 will be supplied to the entire region across the toner passage hole and around the hole area thereof. As a result, the length of the pixels formed on the image receiving means 7 will not be reduced in the main scanning direction. The pixels can be formed with a size required to form an image of a prescribed resolution (600 pdi in the present embodiment). Accordingly, thin white lines as described above will not be produced. Moreover, increasing the traveling speed of the toner holding element 10 makes it possible to compensate for reduction in recording density resulting from reduction in toner supply amount.

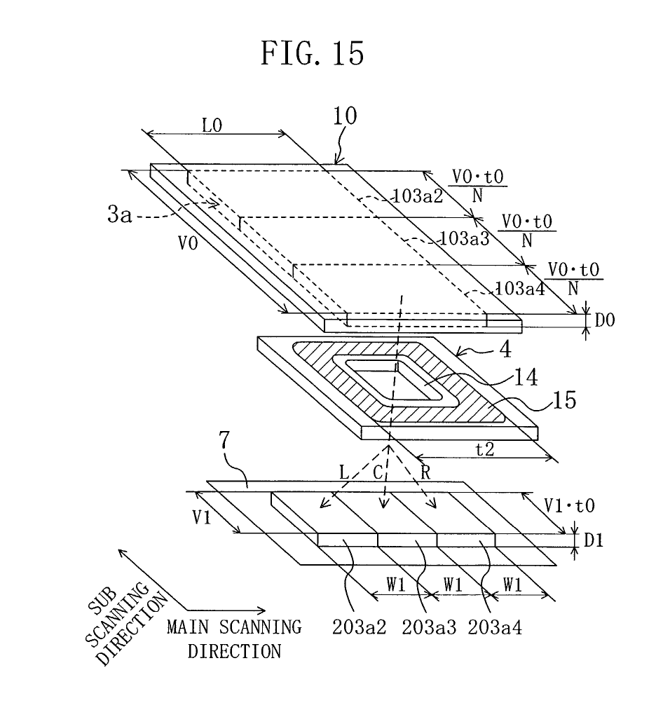

Like the first embodiment, FIG. 15 illustrates the quantitative relation between the amount of toner supplied from the toner holding element 10 and the pixel size formed on the image receiving means 7 according to the second embodiment. As described above in connection with FIG. 14, the amount of toner supplied to the toner holding element 4 varies between the first toner-driving operation and the second and the following toner-driving operations. The toner supply may actually become problematic on the conditions of solid black recording or the like. The second and the following tone-driving operations predominantly affect the recording density in the solid black recording. Therefore, the quantitative relation between the toner supply amount and the pixel size will now be described for the second and the following toner-driving operations. Note that, in FIGS. 14(b) to (d), the toner supply range is shown to have a concave profile corresponding to the profile of the control electrode 15. In the following description, however, it is assumed that the toner supply range is a rectangular region having the same width and height.

As shown in FIG. 15, the toner 3 is deflected to the left (L), central (C) and right (R) directions after passing through the toner passage hole 14. As a result, pixels 203a2, 203a3, 203a4 are successively formed on the image receiving means 7 in the main scanning direction. Provided that V1 is the traveling speed of the image receiving means 7 and t0 is a period required to record a single line (i.e., line period), the image receiving means 7 moves by the distance of (V1×t0) during the line period to. L1 is the length of the pixel in the main scanning direction and corresponds to the pixel pitch in the main scanning direction. In the present embodiment, the pixel pitch is 42 μm (600 dpi). Therefore, L1 is about 42 μm. D1 is the weight of the toner per unit area of the pixels. In the present embodiment, L1=42 μm, D1=0.5 mg/cm², and V1=80 mm/sec, as described above.

In the present embodiment, the control electrode 15 surrounding the toner passage hole 14 in the toner passage controller 4 has a length t2 of 170 μm in the main scanning direction.

The toner for the pixels 203a2, 203a3, 203a4 is supplied from toner supply ranges 103a2, 103a3, 103a4 of the toner layer 3a on the toner holding element 10, respectively. Provided that V0 is the traveling speed of the toner holding element 10, the toner holding element 10 moves by the distance of (V0×t0) during recording of each line. L0 is the length of the toner supply range in the main scanning direction. As described above, L0 is equal to the length t2 (=L0) of the control electrode 15. D0 is the weight of the toner per unit area of the toner layer. Provided that N is the number of pixels successively formed at different positions along the main scanning direction through the same toner passage hole 14 (herein, N=3), each toner supply range has a length of (V0×t0)/N in the sub-scanning direction. In the present embodiment, L0=120 μm, D0=0.5 mg/cm², and V0=100 mm/sec, as described above.

As described above in connection with FIG. 14, a required amount of toner 3 is supplied and transferred from the toner holding element 10 to the image receiving means 7. Therefore, the toner supply ranges 103a2 to 103a4 have the same relation with the respective pixels 203a2 to 203a4 in terms of the toner amount. In other words, the amount of toner in each toner supply range 103a2 to 103a4, (L0×D0×(⅓)×V0×t0), is equal to the amount to toner in the corresponding pixel 203a2 to 203a4, (L1×D1×V1×t0). Therefore, the above expression (1) is obtained.

In order to prevent shortage of toner supply from the toner holding element 10, the amount of toner to be supplied (the left side in the above expression (1)) must be equal to or greater than the amount of toner to be consumed (the right side in the above expression (1)). The traveling speed V0 of the toner holding element 10 for preventing shortage of toner supply is thus calculated. The foregoing description is the same as that in the first embodiment.

The quantitative relation between the toner supply amount and the pixel size will now be described for the downstream row 14b of the toner passage holes 14. Regarding the upstream row 14a of the toner passage holes 14, the length Lo of the toner supply range in the main scanning direction is equal to the length t2 of the control electrode 15 in the main scanning direction. Regarding the downstream row 14b of the toner passage holes 14, however, the length Lo of the toner supply range in the main scanning direction is equal to the distance t3 between adjacent control electrodes 15 of FIG. 14 in the main scanning direction (84 μm in the present embodiment). The quantitative relation between the amount of toner supplied from the toner holding element 10 and the pixel size formed on the image receiving means 7 is otherwise the same as that for the upstream row of the toner passage holes. A required amount of toner 3 is thus supplied and transferred from the toner holding element 10.

By replacing the length Lo of the toner supply range in the main scanning direction in the above expression (1) with the distance t3 between adjacent control electrodes 15 in the main scanning direction, the traveling speed of the toner holding element 10 for preventing shortage of toner supply therefrom is calculated. In the downstream row 14b of the toner passage holes 14, the length of the toner supply range in the main scanning direction is smaller than that in the upstream row 14a. In order to compensate for such a difference in length of the toner supply range and supply a required amount of toner, the toner holding element need move at a higher speed in the downstream row 14b. The traveling speed of the toner holding element 10 is thus preset so that the amount of toner 3 required to obtain a sufficient image density is supplied to the downstream row 14b of the toner passage holes 14. Moreover, the applied voltage and the voltage application time to the control electrodes 15 are reduced in the upstream row 14a of the toner passage holes 14 receiving a larger amount of toner. As a result, the same image density can be obtained in both upstream and downstream rows 14a, 14b of the toner passage holes 14.

It is now assumed that, unlike the present embodiment, the distance t3 between adjacent control electrodes 15 in the main scanning direction in the upstream row 14a of the toner passage holes 14 is equal to or larger than the length t2 of the control electrode 15 in the main scanning direction in the downstream row 14b of the toner passage holes 14. In this case, the toner-less region produced in the upstream row 14a will not overlap the toner supply range in the downstream row 14b. Therefore, the amount of toner 3 supplied to the downstream row 14b will not become smaller than that supplied to the upstream row. As a result, the recording density will not be reduced in the downstream row 4b. Moreover, the traveling speed of the toner holding element 10 required to prevent shortage of toner supply therefrom is the same in both rows 14a, 14b. As a result, the applied voltage and the voltage application time to the control electrodes 15 can be controlled on the same conditions for the rows 14a, 14b.

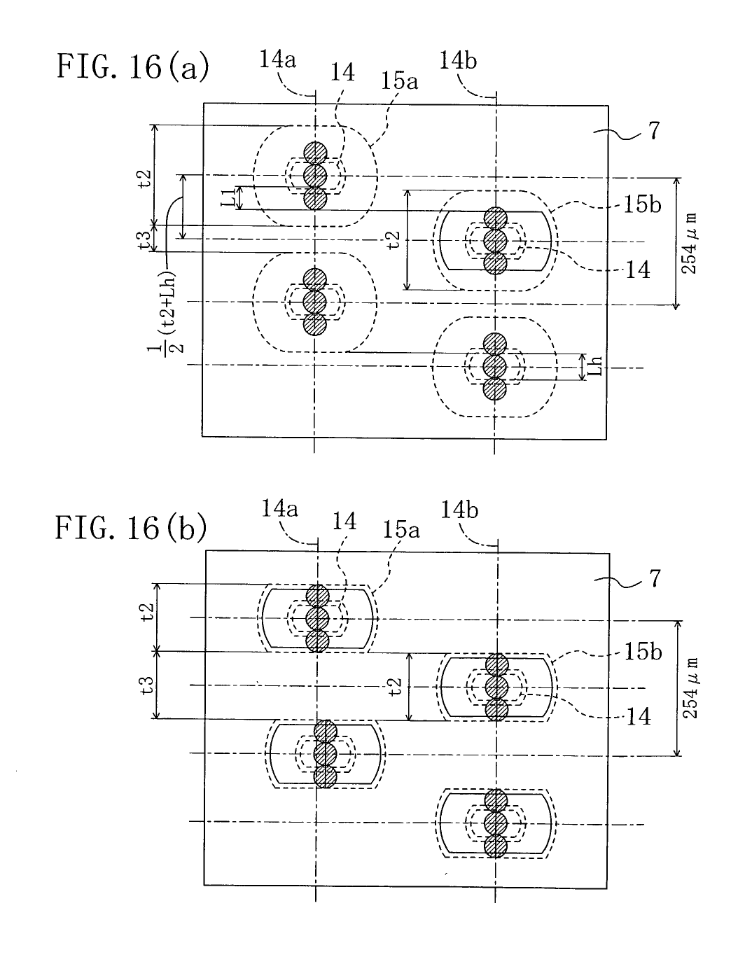

Hereinafter, an appropriate range of the length t2 of the control electrode 15 in the main scanning direction will be described. FIGS. 16(a) and (b) are plan views of the pixels on the image receiving means 7 as viewed from the toner passage controller 4. These figures show the relation between the pixel size to be formed on the image receiving means 7 and the size of the control electrode 15. Dashed lines 14a, 14b and 15a, 15b indicate the respective positions of the toner passage holes 14 and the control electrodes 15 projected on the image receiving means 7.

FIG. 16(a) corresponds to the structure shown in FIG. 14. The length t2 of the upstream control electrode 15a in the main scanning direction is preset so that the distance t3 between adjacent control electrodes 15 is equal to or larger than the length Lh of the downstream toner passage hole 14 in the main scanning direction. In the above structure, provided that L1 is a pixel pitch in the main scanning direction and N is the number of pixels successively formed at different positions in the main scanning direction through the same toner passage hole 14, the length t2 of the control electrode 15 in the main scanning direction satisfies the following expression:

(t2+Lh)/2=N×L1 (5).

Therefore, the following expression is obtained:

t2=2×N×L1−Lh (6).

It is herein assumed that each control electrode 15 has a greater length t2 in the main scanning direction, and the distance t3 between adjacent control electrodes 15 in the main scanning direction is smaller than the length Lh of the toner passage hole 14 in the main scanning direction. In this case, each of the toner-less regions produced by the upstream row 14a of the toner passage holes 14 will overlap the corresponding downstream toner passage hole 14, as described before. Therefore, the toner 3 will not be supplied to a region around the hole area of each downstream toner passage hole 14, whereby the pixels formed on the image receiving means 7 have a reduced length in the main scanning direction. As a result, thin white lines are produced between the pixels formed by the downstream toner passage holes and the pixels formed by the upstream toner passage holes. Therefore, the length t2 of the control electrode 15 in the main scanning direction as defined by the above equation (3) is the maximum value of t2. The upper limit of t2 is defined by the following expression:

t2≦2×N×L1−Lh (7)

In FIG. 16(b), unlike the present embodiment, the length t2 of the upstream control electrode 15a in the main scanning direction is preset so that the distance t3 between adjacent control electrodes 15 is equal to or larger than the length t2 of the downstream control electrode 15b in the main scanning direction. In this structure, provided that L1 is a pixel pitch in the main scanning direction and N is the number of pixels successively formed at different positions in the main scanning direction through the same toner passage hole, the length t2 of the control electrode 15 in the main scanning direction satisfies the following expression:

t2=N×L1 (8).

In this structure, each of the toner-less regions produced by the upstream row 14a of the toner passage holes 14 will not overlap any toner supply range in the downstream row 14b of the toner passage holes 14, as described before. Therefore, the amount of toner supplied to the downstream row 14b will not become smaller than that supplied to the upstream row. As a result, the recording density will not be reduced in the downstream row 4b. Moreover, the traveling speed of the toner holding element 10 required to prevent shortage of toner supply therefrom is the same in the upstream and on the same conditions.

One way to prevent thin white lines from being produced due to shortage of toner supply to the downstream row 14b is to reduce the length t2 of the control electrode 15 in the main scanning direction. This is effective in reducing the width of the toner-less regions produced in the upstream row 14a. However, even if the length t2 is reduced so that the distance t3 between adjacent control electrodes 15 is equal to or larger than the length t2 of the downstream control electrode 15b in the main scanning direction, that is, even if the length t2 is reduced to a value equal to or smaller than the value defined by the above expression (8), the toner 3 in the region corresponding to the length of the downstream control electrode 15b in the main scanning direction will be consumed in the downstream row 14b. It is not so effective to supply the toner 3 of a region having a larger width. Accordingly, the length t2 of the control electrode 15 in the main scanning direction as defined by the above expression (5) is the minimum value of t2. The lower limit of t2 is defined by the following expression:

t2≧N×L1 (9).

As has been described above, in the image forming apparatus of the present embodiment, the toner 3 is supplied from the toner layer 3a on the toner holding element 10 to the toner passage controller 4. The respective voltages applied to the control electrodes 15 and the deflecting electrodes 17a, 17b are sequentially switched so as to driven the toner 3 in three different directions in the main scanning direction. As a result, pixels are formed on the image receiving means 7. When the size of the control electrodes 15 in the rows of the toner passage holes and the relation between the control electrodes 15 in the upstream and downstream rows 14a, 14b of the toner passage holes 14 are preset according to the above conditions, the amount of toner 3 required to obtain a sufficient recording density can be supplied from the toner holding element 10 to every row of the toner passage holes, thereby preventing shortage of toner supply to the toner passage holes 14. This ensures a required recording density when the voltages are applied on the prescribed conditions, and also enables stable formation of a high-quality image without generating thin white lines and causing reduction in density of the recorded image.

Moreover, in the present embodiment, a plurality of pixels are formed at different positions in the main scanning direction through the same toner passage hole 14. This enables adjacent toner passage holes 14 in the main scanning direction to be located away from each other. As a result, the control electrodes 15 and the toner passage holes 14 can be easily arranged so that the upstream control electrodes 15a do not overlap the downstream control electrodes 15b or the toner passage holes 14 in the main scanning direction. As a result, shortage of toner supply can be prevented in every row of the toner passage holes. Thus, the above effects can be obtained.

Note that, according to each of the above embodiments, the toner is driven in three directions from the same toner passage hole 14 in order to form three pixels at different positions in the main scanning direction. However, a single pixel may be formed from the same toner passage hole 14. In this case as well, the same effects can be obtained by applying the present invention.

According to each of the above embodiments, the toner passage controller 4 has a multiplicity of toner passage holes 14 arranged in the direction perpendicular to the moving direction of the toner holding element 10. The toner passage holes 14 are also arranged in two rows located upstream and downstream in the moving direction of the toner holding element 10 a staggered manner. However, the toner passage holes 14 may be arranged in one or more rows at an appropriate pitch.

Moreover, in each of the above embodiments, the weight of the toner per unit area is used as a parameter indicating the amount of toner in the toner layer 3a on the toner holding element 10 and the amount of toner of the pixels formed on the image receiving means 7. However, such an amount of toner may be defined by the thickness of the toner layer or the toner density.

(Industrial Applicability)

The image forming apparatus including a toner holding element and a toner passage controller having a plurality of toner passage holes for controlling passage of the toner according to the present invention is highly applicable in the industry in that it is capable of preventing shortage of toner supply from the toner holding element, obtaining a sufficient image density, preventing generation of thin white lines, and forming a satisfactory, high-quality image, and facilitating practical application of the image forming apparatus.

What is claimed is:

1. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein a traveling speed of the toner holding element is preset based on a traveling speed of the image receiving means and at least one of a weight per unit area or a length in the scanning direction of the toner that is applied to the image receiving means, a weight per unit area of the toner held on the toner holding element or a length of a toner-less region in the main scanning direction, and the number of pixels successively formed at different positions in the main scanning direction through the same toner passage hole.

2. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein a traveling speed of the toner holding element is preset based on a traveling speed of the image receiving means and at least one of a ratio of a weight per unit area of the toner that is applied to the image receiving means to a weight per unit area of the toner held on the toner holding element, a ratio of a length in a main scanning direction of the toner that is applied to the image receiving means to a length in the main scanning direction of a toner-less region of the toner holding element, and the number of pixels successively formed at different positions in the main scanning direction through the same toner passage hole.

3. The image forming apparatus according to claim 1 or 2, wherein the traveling speed of the toner holding element is proportional to a product of the traveling speed of the image receiving means and at least one of the ratio of the weight per unit area of the toner that is applied to the image receiving means to the weight per unit area of the toner held on the toner holding element, the ratio of the length in the main scanning direction of the toner that is applied to the image receiving means to the length in the main scanning direction of the toner-less region of the toner holding element, and the number of pixels successively formed at different positions in the main scanning direction through the same toner passage hole.

4. The image forming apparatus according to claim 3, wherein the traveling speed of the toner holding element is at least a product of the traveling speed of the image receiving means and the ratio of the weight per unit area of the toner that is applied to the image receiving means to the weight per unit area of the toner held on the toner holding element, the ratio of the length in the main scanning direction of the toner that is applied to the image receiving means to the length in the main scanning direction of the toner-less region of the toner holding element, and the number of pixels successively formed at different positions in the main scanning direction through the same toner passage hole.

5. The image forming apparatus according to claim 4, comprising a means for determining the traveling speed V0 of the toner holding element according to the following expression:
V0≧N×(D1/D0)×(L1/L0),
where D1 is the weight per unit area of the toner that is applied to the image receiving means,
D0 is the weight per unit area of the toner held on the toner holding element,
L1 is the length in the main scanning direction of the toner that is applied to the image receiving means,
L0 is the length in the main scanning direction of the toner-less region of the toner holding element,
N is the number of pixels successively formed at different positions in the main scanning direction through the same toner passage hole, and
V1 is the traveling speed of the image receiving means.

6. The image forming apparatus according to any one of claims 1 to 5, wherein the length of the toner-less region of the toner holding element in the main scanning direction is approximately equal to a length of the control electrode in the main scanning region.

7. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein a traveling speed of the toner holding element is one to two times that of the image receiving element.

8. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein each control electrode in a row of toner passage holes located upstream in a moving direction of the toner holding element is arranged so as not to overlap any toner passage hole of a row located downstream in the moving direction of the toner holding element, when viewed from a direction in parallel with the moving direction of the toner holding element.

9. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein each control electrode on a row of toner passage holes located upstream in a moving direction of the toner holding element is arranged so as not to overlap any control electrode in a row of toner passage holes located downstream in the moving direction of the toner holding element, when viewed from a direction in parallel with the moving direction of the toner holding element.

10. The image forming apparatus according to claim 8 or 9, wherein a plurality of pixels are successively formed at different positions in a main scanning direction through the same toner passage hole.

11. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein a length of the control electrode in a main scanning direction, t2, is determined according to the following expression:
NP≦t2≦2NP−Lh,
where N is the number of pixels successively formed at different positions in the main scanning direction through the same toner passage hole,
P is a pitch at which pixels are formed on the image receiving means in the main scanning direction, and
Lh is a length of the toner passage hole in the main scanning direction.

12. An image forming apparatus, comprising:
a toner holding element holding charged toner, and moving while forming a toner layer thereon;
a back electrode mounted at a position facing a position to which the toner on the toner holding element is conveyed, and receiving a voltage for forming a transferring electrostatic field that attracts the toner on the toner holding element; and
a toner passage controller mounted between the toner holding element and the back electrode, and including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal, the image forming apparatus further comprising:
an image receiving means disposed between the toner passage controller and the back electrode, and receiving the toner through the toner passage holes,
wherein the number of pixels successively formed at different positions in a main scanning direction through the same toner passage hole, N, is determined according to the following expression:
(t2+Lh)/2P≦N≦t2/P,
where P is a pitch at which the pixels are formed on the image receiving means in the main scanning direction,
Lh is a length of the toner passage hole in the main scanning direction, and
t2 is a length of the control electrode in the main scanning direction.

13. A toner passage controller mounted at a position facing a toner holding element holding charged toner and moving while forming a toner layer thereon, the toner passage controller including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal,
wherein each control electrode on a row of toner passage holes located upstream in a moving direction of the toner holding element is arranged so as not to overlap any toner passage hole of a row located downstream in the moving direction of the toner holding element, when viewed from a direction in parallel with the moving direction of the toner holding element.

14. A toner passage controller mounted at a position facing a toner holding element that holds charged toner and moves while forming a toner layer thereon, the toner passage controller including an insulating member and control electrodes formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal,
wherein each control electrode on a row of toner passage holes located upstream in a moving direction of the toner holding element is arranged so as not to overlap any control electrode in a row of toner passage holes located downstream in the moving direction of the toner holding element, when viewed from a direction in parallel with the moving direction of the toner holding element.

15. A toner passage controller mounted at a position facing a toner holding element holding charged toner and moving while forming a toner layer thereon, the toner passage controller including an insulating member and control electrode formed thereon, wherein the insulating member has a row of a plurality of toner passage holes for passing the toner therethrough, each control electrode surrounds at least a part of the respective toner passage hole, and the toner passage controller controls passage of the toner through each toner passage hole in response to a voltage applied to the respective control electrode according to an image signal,
wherein a length of the control electrode in a main scanning direction, t2, is determined according to the following expression:
NP≦t2≦2NP−Lh,
where N is the number of pixels successively formed at different positions in the main scanning direction through the same toner passage hole,
P is a pitch at which pixels are formed on the image receiving means in the main scanning direction, and
Lh is a length of the toner passage hole in the main scanning direction.

16. A method for forming an image, comprising the steps of:
holding charged toner on a toner holding element and moving the toner holding element while forming a toner layer thereon;
applying to a back electrode a voltage for forming a transferring electrostatic field that attracts the toner on the toner holding element, the back electrode being mounted at a position facing a position to which the toner on the toner holding element is conveyed; and
controlling passage of toner through toner passage holes in a toner passage controller by applying a voltage to control electrodes according to an image signal, wherein the toner passage controller is mounted between the toner holding element and the back electrode and includes an insulating member and control electrodes formed thereon, the insulating member has a row of a plurality of toner passage holes for passing the toner therethrough, and each control electrode surrounds at least a part of the respective toner passage hole, the method further comprising the step of:
applying the toner to an image receiving means through the toner passage holes, the receiving means being disposed between the toner passage controller and the back electrode,
wherein the number of pixels successively formed at different positions in a main scanning direction through the same toner passage hole, N, is determined according to the following expression:
(t2+Lh)/2P≦N≦t2/P,
where P is a pitch at which the pixels are formed on the image receiving means in the main scanning direction,
Lh is a length of the toner passage hole in the main scanning direction, and
t2 is a length of the control electrode in the main scanning direction.
